(19) United States
(12) Patent Application Publication
(10) Pub. No.: US 2024/0303977 A1
(43) Pub. Date: Sep. 12, 2024

(54) IMAGE PROCESSING DEVICE AND IMAGE PROCESSING METHOD

(71) Applicant: Keyence Corporation, Osaka (JP)

(72) Inventor: Yasuhisa IKUSHIMA, Osaka (JP)

(73) Assignee: Keyence Corporation, Osaka (JP)

(21) Appl. No.: 18/443,381

(22) Filed: Feb. 16, 2024

(30) Foreign Application Priority Data
Mar. 7, 2023 (JP) 2023-034671

(51) Int. Cl. G06V 10/776; G06V 10/764; G06V 10/774; G06V 10/82; G06V 10/86; G06V 10/94; G06V 20/50

(52) U.S. Cl. CPC G06V 10/776; G06V 10/764; G06V 10/774; G06V 10/86; G06V 10/945; G06V 20/50; G06V 10/82

(57) ABSTRACT

A processor: executes classification of classifying a plurality of validation images into a plurality of classes with a machine learning model trained with a plurality of training images; obtains a degree of separation between the plurality of classes by the classification of the plurality of validation images and evaluates accuracy of the classification of the plurality of validation images based on the obtained degree of separation between the plurality of classes; and evaluates whether re-training of the machine learning model is necessary based on an evaluation result of the accuracy of classification of the plurality of validation images, extracts an validation image whose classification result has a relatively high possibility to be erroneous from among the plurality of validation images to automatically re-train the machine learning model if it is evaluated that the re-training of the machine learning model is necessary.

### CROSS-REFERENCE TO RELATED APPLICATIONS

The present application claims foreign priority based on Japanese Patent Application No. 2023-034671, filed Mar. 7, 2023, the contents of which are incorporated herein by reference.

### BACKGROUND OF THE INVENTION

### Field of the Invention

The present disclosure relates to an image processing device including a processor and an image processing method for processing images with a machine learning model.

### Description of Related Art

For example, there has been an inspection device for performing appearance inspection of an industrial product. The inspection device is configured to input a target image acquired by an imaging section to a machine learning model and execute classification of determining whether the target image belongs to a non-defective or defective group (for example, see Japanese Patent No. 6643856).

In the inspection device disclosed in Japanese Patent No. 6643856, a machine learning model is trained using training images belonging to the non-defective group, training images belonging to the defective group, and the like, and an image that is ambiguous as to whether it belongs to the non-defective group or the defective group is proposed to the user as an additional training image.

In addition, JP-A-2021-196363 discloses that the necessary number of additional defect images for improving the performance of the defect detection unit is presented to the user based on the performance accuracy.

### SUMMARY OF THE INVENTION

The training of machine learning model requires a plurality of training images. However, it is difficult for the user to know which images should be used as the training images from among a plurality of images. Therefore, the training of machine learning model becomes trial and error, which may increase the burden on the user and increase the number of training images and the training time. In addition, over-training may occur depending on the determination by the user.

In the case of the inspection device of Japanese Patent No. 6643856, a training image can be proposed to the user, but the user needs to determine whether to input the proposed training image to the machine learning model for training, which is a heavy burden on the user. In addition, it is difficult for the user to confirm whether the accuracy of the classification by the machine learning model is sufficient, which is a heavy burden on the user who performs the confirmation. Furthermore, if it is determined as the result of the confirmation that the accuracy of the classification is insufficient and additional training is necessary, the user needs to perform training using the training images again, which also causes an increase in the burden on the user.

Further, in the case of the defect detection system of JP-A-2021-196363, it is possible to present the necessary number of additional defect images for improving the performance of the defect detection unit to the user based on the performance accuracy. However, the user has to determine the type of the training images to be added, which is a heavy burden on the user.

The present disclosure has been made in view of the above, and an object thereof is to reduce the burden on the user by automatically executing training, inspection, and re-training of a machine learning model until the accuracy of classification becomes sufficient.

In order to achieve the above object, the present aspect can be assumed as an image processing device including a processor configured to input an image to a machine learning model and execute classification of classifying the image into a plurality of classes. The processor: trains the machine learning model with a plurality of training images; inputs a plurality of validation images to the machine learning model trained with the plurality of training images, and executes classification of classifying the plurality of validation images into the plurality of classes; obtains a degree of separation between the plurality of classes by the classification of the plurality of validation images and evaluates accuracy of the classification of the plurality of validation images based on the obtained degree of separation between the plurality of classes; and evaluates whether re-training of the machine learning model is necessary based on an evaluation result of the accuracy of classification of the plurality of validation images, extracts an validation image whose classification result has a relatively high possibility to be erroneous from among the plurality of validation images to automatically re-train the machine learning model if it is evaluated that the re-training of the machine learning model is necessary, and completes the training of the machine learning model if it is evaluated that the re-training of the machine learning model is unnecessary.

According to this configuration, after training the machine learning model with the plurality of training images, the machine learning model can be inspected by inputting the plurality of validation images to the machine learning model and performing the classification. If the accuracy of the classification evaluated based on the degree of separation obtained by the validation is insufficient, the validation image whose classification result has a relatively high possibility to be erroneous is input to the machine learning model to automatically re-train the machine learning model. On the other hand, if the accuracy of the classification evaluated based on the degree of separation obtained by the validation is sufficient and re-training of the machine learning model is unnecessary, the training of the machine learning model is completed. According to the present configuration, training, validation, and re-training of the machine learning model are automatically executed, so that the burden on the user is reduced. Further, at the time of re-training, efficient training can be performed by using the validation image whose classification result has a relatively high possibility to be erroneous.

The processor may automatically repeat, until it is evaluated that the re-training of the machine learning model is unnecessary: the classification; the evaluation of the accuracy of the classification; the evaluation as to whether the re-training of the machine learning model is necessary; and the re-training. That is, examples of the case where re-training is unnecessary include a case where a sufficient accuracy of the classification is obtained, a case where the accuracy of the classification reaches a peak instead of being improved even if additional training images are input, and a case where the training images are insufficient. However, for example, it is difficult for the user to determine that a sufficient accuracy of the classification is obtained or to determine the time point at which the accuracy of the classification reaches a peak instead of being improved. Therefore, the image processing device according to the present aspect automatically repeats the above-described re-training process, so that the user does not need to make the above-described determinations, which can further reduce the burden on the user.

The image processing device can also execute classification of classifying the plurality of validation images into a first class and a second class. In this case, the processor may calculate a first evaluation value indicating a degree of belonging to the first class for each of the plurality of validation images. If it is evaluated that the re-training of the machine learning model is necessary, the processor may extract the second-class image having a relatively high first evaluation value or the first-class image having a relatively low first evaluation value to automatically re-train the machine learning model. Further, the processor may obtain a degree of separation of distribution between the first-class image and the second-class image, and repeat, until it is evaluated that the re-training of the machine learning model is unnecessary based on the degree of separation: the classification; the evaluation of the accuracy of the classification; the evaluation as to whether the re-training of the machine learning model is necessary; and the re-training. That is, the accuracy of the classification can be further improved by using the first evaluation value indicating the degree of belonging to the first class as the basis of the evaluation as to whether the re-training is necessary.

When the image processing device executes the classification of classifying the plurality of validation images into the first class and the second class, the processor may repeat, until the degree of separation of distribution between the first-class image and the second-class image becomes equal to or greater than a predetermined value: the classification; the evaluation of the accuracy of the classification; the evaluation as to whether the re-training of the machine learning model is necessary; and the re-training.

The plurality of validation images may include a non-defective product image given a non-defective label and a defective product image given a defective label. In this case, the processor may calculate an evaluation value indicating a degree of defect for each of the plurality of validation images in the classification. If the re-training is necessary, the processor may extract a non-defective product image having a relatively high evaluation value or a defective product image having a relatively low evaluation value to automatically re-train the machine learning model. Further, the processor may obtain a degree of separation of distribution between the non-defective product image and the defective product image on an evaluation value axis, and repeat, until the degree of separation becomes equal to or greater than a predetermined value: the classification; the evaluation of the accuracy of the classification; the evaluation as to whether the re-training of the machine learning model is necessary; and the re-training.

The processor may automatically determine which of the non-defective product image having a relatively high evaluation value and the defective product image having a relatively low evaluation value is to be extracted as an image for re-training the machine learning model based on a result of comparison between the evaluation value of the non-defective product image and the evaluation value of the defective product image among the plurality of validation images. Accordingly, the image processing device automatically determines which of the non-defective product image and the defective product image is an image having a higher training effect, which can further reduce the burden on the user.

The processor may further calculate a second evaluation value indicating a degree of belonging to the second class for each of the plurality of validation images in the classification. In this case, if it is evaluated that the re-training of the machine learning model is necessary, the processor may extract the first-class image having a relatively high second evaluation value or the second-class image having a relatively low second evaluation value to automatically re-train the machine learning model. Further, the processor may obtain a degree of separation of distribution between the first-class image and the second-class image on a second evaluation value axis, and repeat, until it is evaluated that the re-training of the machine learning model is unnecessary based on the degree of separation: the classification; the evaluation of the accuracy of the classification; the evaluation as to whether the re-training of the machine learning model is necessary; and the re-training. This enables efficient training.

The processor may automatically calculate the number of validation images used for re-training based on an evaluation result of the accuracy of the classification, and automatically re-train the machine learning model with the validation images by the calculated number. That is, the image processing device automatically determines the number of images to be added at the time of re-training according to the accuracy of the classification, which can reduce the work burden on the user.

The processor may extract the validation images by the calculated number in descending order of possibility of the classification result being erroneous to automatically re-train the machine learning model. That is, it is possible to not only automatically calculate the number of validation images used for re-training, but also have the image processing device decide the criterion for selecting the images by the calculated number, which can reduce the work burden on the user.

The processor may generate a display screen including a separation graph indicating the degree of separation of distribution between the first-class image and the second-class image on the first evaluation value axis and causes a display unit to display the display screen after executing the classification. Further, the processor may update the separation graph to the separation graph obtained by the machine learning model after the re-training, generate a display screen displaying a latest separation graph obtained by the update in a manner comparable to a past separation graph, and cause the display unit to display the display screen. Accordingly, if re-training is necessary, it is possible to show the progress of the training to the user with the display screen. In addition, if re-training is unnecessary, the display screen can be presented to the user as a final evaluation result.

The processor may be configured to generate a display screen displaying, in a comparable manner, a latest separation graph obtained by repeatedly re-training the machine learning model and a past separation graph, cause the display unit to display the display screen, and receive selection of a past machine learning model corresponding to the past separation graph from a user as a machine learning model to be used in operation. In this case, when selection of the past machine learning model is received, the processor may identify all training images for training the selected past machine learning model, and train a machine learning model in an initial state before starting training with all the identified training images, thereby reproducing the selected past machine learning model. That is, although the accuracy of the classification may be higher in the past machine learning model in the training stage before the latest machine learning model in which re-training is repeated, it is generally difficult to return from the latest machine learning model to the past machine learning model. In contrast, the present configuration trains the machine learning model in the initial state with all the training images for training the past machine learning model selected by the user, thereby easily reproducing the past machine learning model.

The processor may be configured to restart the re-training of the machine learning model in response to a user instruction. In this case, the processor may input a new validation image different from an existing validation image to the machine learning model and execute a process of classifying the new validation image into the plurality of classes. The processor may evaluate accuracy of the classification based on a degree of separation between the plurality of classes obtained by the classification for the new validation image. If it is evaluated that the re-training of the machine learning model is necessary, the processor may extract an validation image whose classification result has a high possibility to be erroneous from among the new validation image to automatically re-train the machine learning model. Accordingly, even if a new image is acquired after the training is once completed, it is possible to re-train the existing machine learning model according to the user instruction, which can continuously improve the accuracy of the machine learning model.

The processor may be configured to select: a process of holding in advance labels related to the classification of existing training images and validation images used for the training of the machine learning model in operation and adding a training image by adding a new image acquired after starting the operation to the existing training images; and a process of initializing the labels related to the classification of the existing training images and validation images used for the training of the machine learning model in operation and training the machine learning model with all images including a new image acquired after starting the operation. That is, if the accuracy of the classification of the machine learning model in operation is high, a new image may be added without initialization. However, if the accuracy of the classification of the machine learning model in operation is low, it may be possible to increase the accuracy of the classification by initializing and training the machine learning model with all images. The user can select either one according to the situation.

As described above, it is possible to automatically executing training, validation, and re-training of a machine learning model until the accuracy of classification becomes sufficient, which can reduce the burden on the user.

### BRIEF DESCRIPTION OF THE DRAWINGS

FIG. 1 is a schematic diagram illustrating the configuration of an image processing device according to an embodiment of the present invention;

FIG. 2 is a block diagram illustrating the hardware configuration of the image processing device;

FIG. 3 is a diagram illustrating an example in which a workpiece image is processed by a machine learning model;

FIG. 4 is a flowchart illustrating a first example of step 1 of automatic training;

FIG. 5 is a diagram illustrating an example of an image display user interface screen;

FIG. 6 is a diagram illustrating an example of a training result display user interface screen after ending first training;

FIG. 7 is a diagram corresponding to FIG. 6 illustrating a state in which second training is ended;

FIG. 8 is a diagram corresponding to FIG. 6 illustrating a state in which third training is ended;

FIG. 9 is a flowchart illustrating a first example of step 2 of the automatic training;

FIG. 10 is a flowchart illustrating a second example of step 1 of the automatic training;

FIG. 11 is a flowchart illustrating a second example of step 2 of the automatic training;

FIG. 12 is a flowchart illustrating an example of training with defective products;

FIG. 13 is a diagram illustrating an example of an annotation screen;

FIG. 14 is a diagram illustrating an example of a training transition display screen;

FIG. 15 is a diagram illustrating an example of a training result display area in the case of three-class classification; and

FIG. 16 is a flowchart illustrating an example of automatic training in the case of three-class classification.

### DETAILED DESCRIPTION

Hereinafter, an embodiment of the present invention will be described in detail with reference to the drawings. The following description of a preferred embodiment is essentially nothing more than an illustration, and is not to limit the present invention, an application thereof, or a usage thereof.

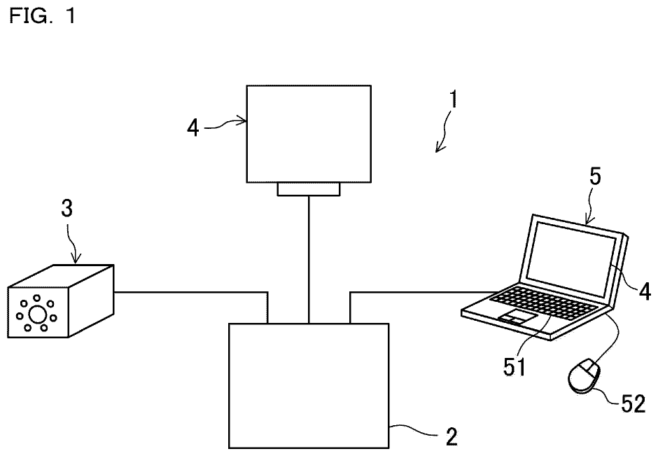

FIG. 1 is a schematic diagram illustrating the configuration of an image processing device 1 according to an embodiment of the present invention. The image processing device 1 is a device for determining the quality of a workpiece image obtained by imaging a workpiece as the inspection target, such as various parts or products, and can be used in a production site such as a factory. Specifically, a machine learning model is constructed inside the image processing device 1, and the machine learning model is generated by training with a plurality of training images.

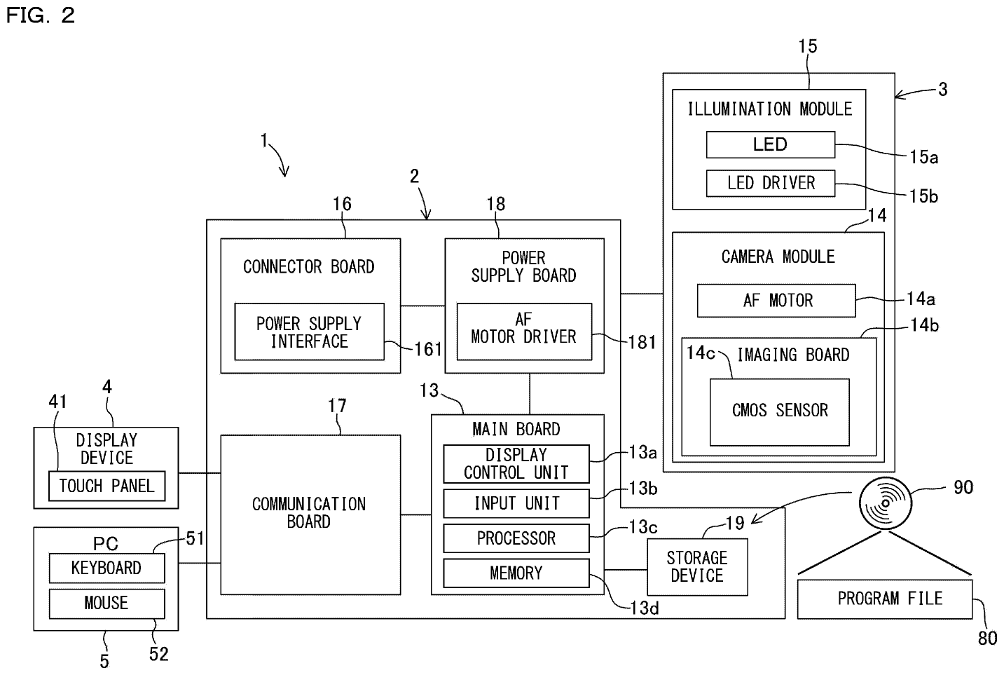

As illustrated in FIG. 2, the image processing device 1 includes a control unit 2 serving as a device body, an imaging unit 3, a display device (display unit) 4, and a personal computer 5. The personal computer 5 is not essential and may be omitted. The personal computer 5 can be used instead of the display device 4 to display various information and images, and the functions of the personal computer 5 can be incorporated into the control unit 2 or into the display device 4.

In FIG. 1, the control unit 2, the imaging unit 3, the display device 4, and the personal computer 5 are illustrated as an example of a configuration example of the image processing device 1, but any ones among them can be combined and integrated. For example, the control unit 2 and the imaging unit 3 may be integrated, or the control unit 2 and the display device 4 may be integrated. Further, the control unit 2 may be divided into a plurality of units and some may be incorporated into the imaging unit 3 or the display device 4, or the imaging unit 3 may be divided into a plurality of units and some may be incorporated into another unit. The image processing device 1 can be used to execute all the steps of the image processing method according to the present invention.

### Configuration of Imaging Unit 3

As illustrated in FIG. 2, the imaging unit 3 includes a camera module (imaging section) 14 and an illumination module (illumination section) 15, and is a unit for acquiring a workpiece image. The camera module 14 includes an AF motor 14a for driving an imaging optical system and an imaging board 14b. The AF motor 14a is a part for automatically performing the focus adjustment by driving the lenses of the imaging optical system, and can perform the focus adjustment by a method known in the related art such as contrast autofocus. The imaging board 14b includes a CMOS sensor 14c as a light detection element for detecting light incident from the imaging optical system. The CMOS sensor 14c is an imaging sensor configured to acquire a color image. Instead of the CMOS sensor 14c, a light detection element such as a CCD sensor may be used.

The illumination module 15 includes a light emitting diode (LED) 15a as a light emitting body for illuminating the imaging area including the workpiece, and an LED driver 15b for controlling the LED 15a. The light emission time point, light emission period, and light emission amount of the LED 15a can be controlled freely by the LED driver 15b. The LED 15a may be provided integrally with the imaging unit 3 or may be provided as an external illumination unit separate from the imaging unit 3.

### Configuration of Display Device 4

The display device 4 includes a display panel such as a liquid crystal panel or an organic EL panel, and is controlled by a processor 13c of the control unit 2 described later. The workpiece image and the user interface image output from the control unit 2 are displayed on the display device 4. If the personal computer 5 has a display panel, the display panel of the personal computer 5 can be used instead of the display device 4.

### Operation Device

Examples of the operation device for the user to operate the image processing device 1 include a keyboard 51 and a mouse 52 of the personal computer 5, but are not limited thereto, and may be any device that can receive various operations by the user. For example, a pointing device such as a touch panel 41 of the display device 4 is also included in the operation device.

The operation on the keyboard 51 or the mouse 52 by the user can be detected by the control unit 2. The touch panel 41 is, for example, a touch operation panel known in the related art that is equipped with a pressure-sensitive sensor, and a touch operation by the user can be detected by the control unit 2. The same applies to the case of using other pointing devices.

### Configuration of Control Unit 2

The control unit 2 includes a main board 13, a connector board 16, a communication board 17, and a power supply board 18. The main board 13 is provided with a display control unit 13a, an input unit 13b, and the processor 13c. The display control unit 13a and the input unit 13b can be configured with, for example, an arithmetic device mounted on the main board 13. The display control unit 13a, the input unit 13b, and the processor 13c may be configured with a single arithmetic device, or the display control unit 13a, the input unit 13b, and the processor 13c may be configured with separate arithmetic devices.

The display control unit 13a, the input unit 13b, and the processor 13c control the operations on the connected boards and modules. For example, the processor 13c outputs an illumination control signal for controlling on/off of the LED 15a to the LED driver 15b of the illumination module 15. The LED driver 15b switches on/off and adjusts the lighting time of the LED 15a in response to the illumination control signal from the processor 13c, and adjusts the amount of light of the LED 15a and the like.

The processor 13c outputs an imaging control signal for controlling the CMOS sensor 14c to the imaging board 14b of the camera module 14. The CMOS sensor 14c starts imaging in response to the imaging control signal from the processor 13c, and adjusts the exposure time to any time to perform imaging. That is, the imaging unit 3 images the inside of the visual field range of the CMOS sensor 14c in response to the imaging control signal output from the processor 13c. If a workpiece is within the visual field range, the imaging unit 3 images the workpiece, but if an object other than the workpiece is within the visual field range, the imaging unit 3 can also image the object. For example, the image processing device 1 can capture a non-defective product image corresponding to a non-defective product and a defective product image corresponding to a defective product by the imaging unit 3 as training images for the machine learning model. A training image may not be an image captured by the imaging unit 3, and may be an image captured by another camera or the like.

On the other hand, in operation of the image processing device 1, a workpiece can be imaged by the imaging unit 3. The CMOS sensor 14c is configured to output a live image, that is, a currently captured image at a short frame rate as needed.

When the imaging by the CMOS sensor 14c is completed, the image signal output from the imaging unit 3 is input to and processed by the processor 13c of the main board 13, and is stored in a memory 13d of the main board 13. The details of the specific processing contents by the processor 13c of the main board 13 will be described later. The main board 13 may be provided with a processing device such as an FPGA or a DSP. Alternatively, the processor 13c may be obtained by integrating processing devices such as an FPGA and a DSP.

The connector board 16 is a portion that receives power from the outside via a power supply connector (not illustrated) provided in a power supply interface 161. The power supply board 18 is a portion for distributing the power received by the connector board 16 to each board, module, and the like, and specifically distributes the power to the illumination module 15, the camera module 14, the main board 13, and the communication board 17. The power supply board 18 includes an AF motor driver 181. The AF motor driver 181 supplies driving power to the AF motor 14a of the camera module 14 to achieve autofocus. The AF motor driver 181 adjusts the power supplied to the AF motor 14a in response to the AF control signal from the processor 13c of the main board 13.

The communication board 17 is a part for executing the communication between the main board 13 and the display device 4 and the personal computer 5, the communication between the main board 13 and an external control device (not illustrated), and the like.

Examples of the external control device include a programmable logic controller. The communication may be wired or wireless, and either communication mode can be achieved by a communication module known in the related art.

The control unit 2 is provided with a storage device (storage unit) 19 including, for example, a solid state drive or a hard disk drive. The storage device 19 stores a program file 80, a setting file, and the like (software) for enabling the controls and processes described later to be executed by the above-described hardware. The program file 80 and the setting file are stored in a storage medium 90 such as an optical disk, and the program file 80 and the setting file stored in the storage medium 90 can be installed in the control unit 2. The program file 80 may be downloaded from an external server using a communication line. The storage device 19 may store, for example, the above-described image data, the parameters for constructing a machine learning model of the image processing device 1, and the like.

### Operation of Image Processing Device 1

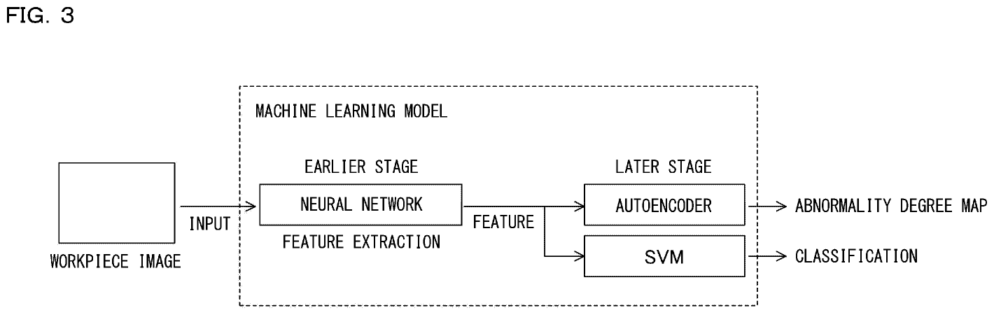

In operation of the image processing device 1, the processor 13c reads the parameters stored in the storage device 19, and a trained machine learning model is constructed by the processor 13c. As illustrated in FIG. 3, the machine learning model includes a neural network, an autoencoder, a support vector machine (SVM), and the like. The processor 13c inputs a workpiece image obtained by imaging a workpiece as the inspection target to the neural network constructed as described above. This is the earlier stage. When the workpiece image is input to the neural network, the neural network performs feature extraction, and the extracted features are input to an autoencoder and/or a support vector machine for executing the later stage. The neural network for performing the feature extraction in the earlier stage may be a convolutional neural network trained in advance, or may be a convolutional neural network configured to be additionally trained using the automatic training described later. In the machine learning model illustrated in FIG. 3, a plurality of features having different scales (feature map) may be extracted from a plurality of layers of the convolutional neural network, and the plurality of features may be input to the autoencoder and/or the support vector machine.

The autoencoder generates and outputs an abnormality degree map (heat map) based on the input features. The processor 13c executes determination of determining whether the workpiece image belongs to a first class or a second class based on the abnormality degree map output from the autoencoder. For example, the first class may be a non-defective class, and the image belonging to the first class may be a non-defective product image obtained by imaging a non-defective product. The second class may be a defective class, and the image belonging to the second class may be a defective product image obtained by imaging a defective product.

On the other hand, the support vector machine executes classification of classifying the workpiece image into a plurality of classes based on the input features. The plurality of classes include the first class and the second class, so that the processor 13c can classify the workpiece image into the non-defective class and the defective class. The plurality of classes may include a third class, a fourth class, and the like, and the number of classes is not particularly limited.

The machine learning model according to the present embodiment is not limited to autoencoder or SVM, and other machine learning models may be used.

The processor 13c of the image processing device 1 can determine whether the workpiece is a non-defective product or a defective product by executing the above-described determination and classification. The image processing device 1 having such a function can inspect the appearance of the workpiece, and thus can be referred to as an appearance inspection device or the like. The workpiece as the inspection target of the image processing device 1 may be the inspection target entirely, or a part of the workpiece may be the inspection target alone. One workpiece may include a plurality of inspection targets. The workpiece image may include a plurality of workpieces.

### Automatic Training

In order to train the machine learning model, a plurality of training images are input to the machine learning model. The training images can be prepared by the user, but it may be difficult for the user to accurately determine which image should be input to the machine learning model for training, which often results in trial and error. In addition, regarding training images used for generating a machine learning model for classifying non-defective products and defective products, an excessively large number of images is not preferable from the viewpoint of an increase in training time and over-training, while an excessively small number of images deteriorates the generalization performance, which makes it difficult to determine the appropriate number of images. Furthermore, it is desirable not only to classify non-defective products and defective products but also to have a large difference between an evaluation value in the case of determining non-defective products and an evaluation value in the case of determining defective products. In summary, the selection of training images requires to satisfy various requirements. Currently, performance is improved by selecting the training images based on the rich know-how possessed by an expert, or by using a large number of images for training if without know-how, despite of the risk of over-training. Therefore, it is difficult for a person with little experience to generate a machine learning model with high accuracy of classification and determination. In addition, since the person who generates a machine learning model has selected the training images, the accuracy of the generated machine learning model varies depending on the person who selected the training images. The image processing device 1 according to the present embodiment can execute automatic training that enables even a person with little experience to automatically generate a machine learning model with high accuracy of classification and high accuracy of determination as in the case of an expert, while reducing the burden. Hereinafter, an example of the automatic training will be described.

The automatic training can be roughly divided into two steps, including step 1 and step 2. In step 1, by only training with non-defective products, generated is a machine learning model for classifying non-defective products and defective products, or for determining whether an image belongs to the non-defective class or the defective class. In this specification, the classification of the input image into the non-defective class or the defective class can also be referred to as quality determination. In step 2, if the classification into the non-defective product and the defective product or the determination succeeded in step 1, the training with defective products is executed to increase the difference between the evaluation value in the case of determining the non-defective products and the evaluation value in the case of determining the defective products. In step 2, if the classification into the non-defective product and the defective product or the determination failed in step 1, the training with defective products is executed to generate a machine learning model for classifying the non-defective products and the defective products or for determining, and to increase the difference between the evaluation value in the case of determining the non-defective products and the evaluation value in the case of determining the defective products. In the case of supervised training, step 1 is omitted and only step 2 is executed.

### First Example of Step 1

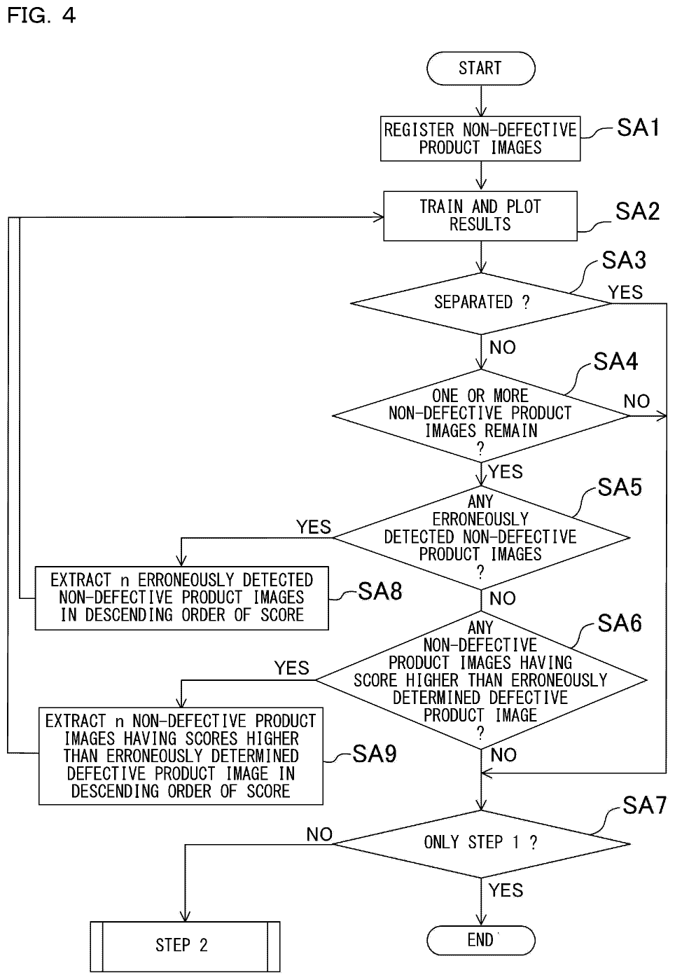

FIG. 4 is a flowchart illustrating an example of step 1 of the automatic training. Before starting the automatic training, the user prepares a plurality of training images. The training images include non-defective product images identified as non-defective products and defective product images identified as defective products. Since the first class is the non-defective class and the second class is the defective class, the non-defective product images can be referred to as first-class images given a label indicating the first class, and the defective product images can be referred to as second-class images given a label indicating the second class.

The non-defective product images and the defective product images are both prepared in plurality. The training images may be only the non-defective product images, but the user needs to prepare both the non-defective product images and the defective product images because both the images are essential as the validation images for inspecting the accuracy of the machine learning model. In addition, a plurality of evaluation images different from the training images and the validation images may be prepared for evaluating the articulation performance of the machine learning model generated in the automatic training. The evaluation images are images for testing whether the machine learning model generated using the training images and the validation images can correctly classify even an unknown image as an evaluation image. If the machine learning model erroneously classifies the evaluation image, the user can determine that the reliability of the machine learning model is low.

The non-defective product images are given a non-defective label, and the defective product image are given a defective label. The non-defective label and the defective label are given to each image by the user. The training images, the validation images, and the evaluation images are stored in a predetermined folder by the user. The validation images may or may not include the training images.

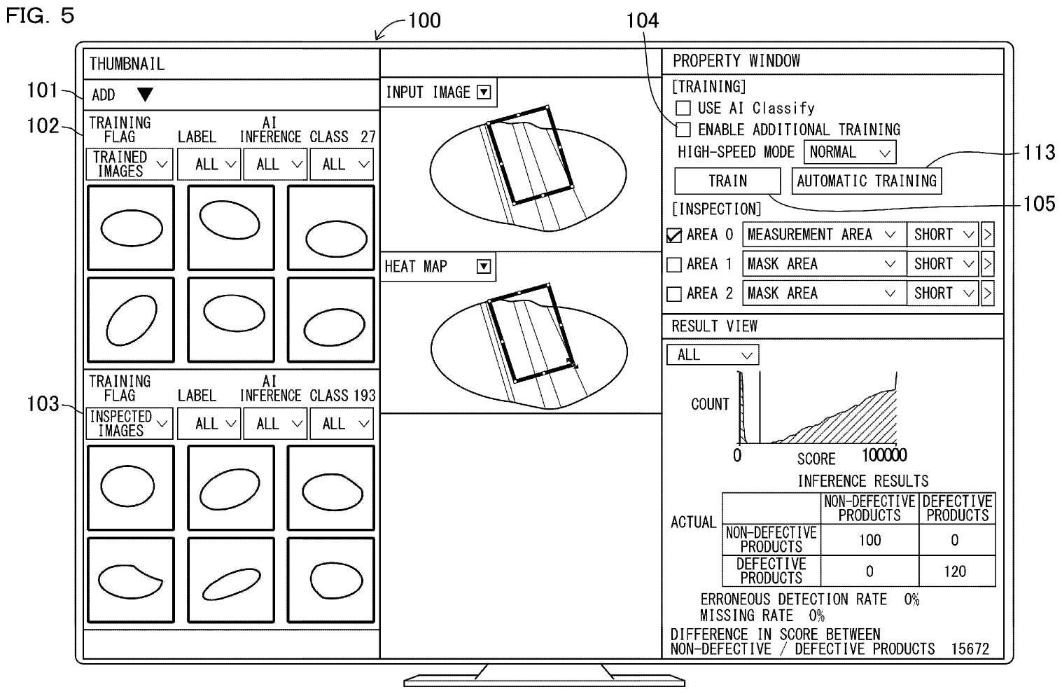

In step SA1, a non-defective product image is registered as a training image for training the machine learning model. The number of training images to be registered may be one or more. In step SA1, the processor 13c generates an image display user interface screen 100 illustrated in FIG. 5 and causes the display device 4 to display the image display user interface screen 100. The image display user interface screen 100 is provided with an image addition button 101, a training image display area 102 for displaying training images in a thumbnail format, and an validation image display area 103 for displaying validation images in a thumbnail format. When the user presses the image addition button 101 by operating the mouse 52, the processor 13c generates a folder selection window (not illustrated) and causes the display device 4 to display the folder selection window. When the user selects the above-described predetermined folder in the folder selection window, all the training images in the folder are read as training images and displayed in the training image display area 102. If the read training images include non-defective product images belonging to the non-defective class and defective product images belonging to the defective class, only the non-defective product images are selected as the images to be used for training in step SA1. This selection operation can be performed, for example, by the user operating the mouse 52, and the selected training images are registered as images to be input to the machine learning model. If a plurality of training images are registered, it is preferable to select images having lower similarity to each other. The training image may be registered by the user as described above, or may be automatically registered by the processor 13c. For example, the processor 13c may automatically select and register the image to be displayed first in the file, or may automatically select and register the images according to the update date. In step SA1, the defective product images can be registered as the training images. In this case, the process shifts to the automatic training in step 2 described later.

After the training images are registered, the process proceeds to step SA2. The image display user interface screen 100 is provided with an automatic training button 113 for starting the automatic training. When the user operates the mouse 52 to press the automatic training button 113, the processor 13c starts the automatic training. Specifically, the processor 13c inputs the training images registered in step SA1 to the machine learning model to perform the training. This is a training step of training the machine learning model with the training images. The training step performed using the non-defective product images generates a machine learning model that determines an image having features different from those of the non-defective product images belonging to the non-defective class as a defective product image belonging to the defective class.

After the training step, the processor 13c inputs the plurality of validation images to the machine learning model trained in the training step, and executes the classification of classifying the plurality of validation images into the non-defective class and the defective class. At this time, the processor 13c also inputs the plurality of validation images to the machine learning model trained in the training step and executes the determination of determining whether the plurality of validation images belong to the non-defective class or the defective class. This is an validation step. In the validation step, the processor 13c can obtain the degree of separation between the non-defective class and the defective class by the classification of the plurality of validation images.

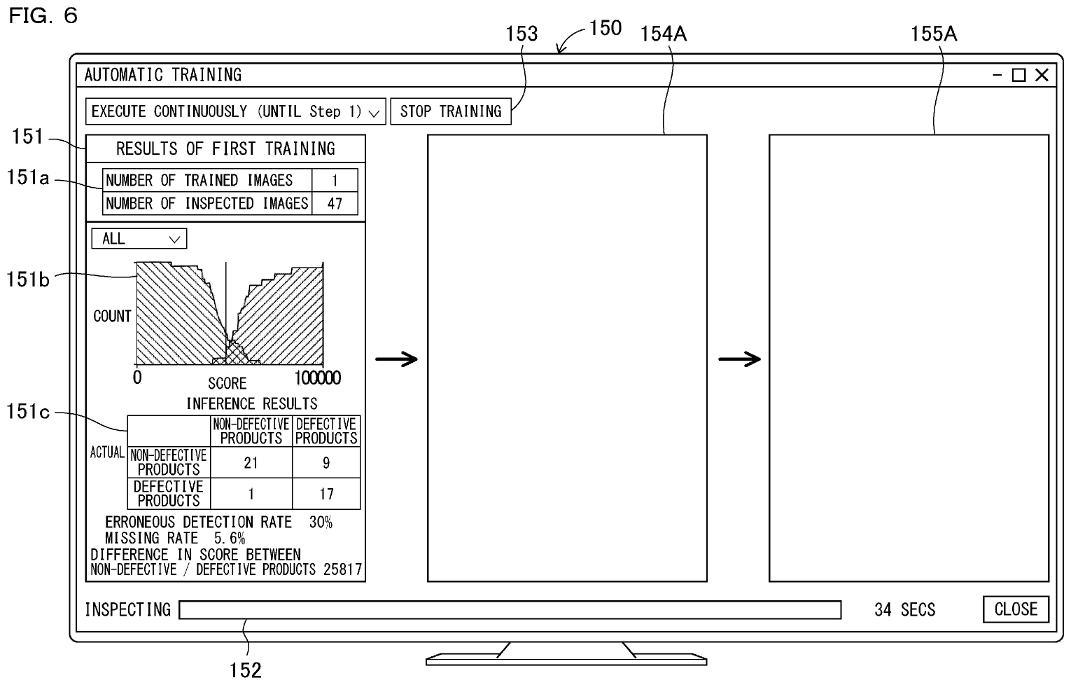

In the validation step, the processor 13c generates a training result display user interface screen 150 as illustrated in FIG. 6 and causes the display device 4 to display the user interface screen 150. The training result display user interface screen 150 is provided with a first training result display area 151 for displaying the training result of the machine learning model obtained in the first validation step, and an validation in-progress display area 152 for indicating that the validation is in progress together with the elapsed time from the start of training. The training result display user interface screen 150 is also provided with a training stop button 153. When the user operates the training stop button 153, the processor 13c forcibly ends the training of the machine learning model even during the training. Further, the training result display user interface screen 150 displays an area 154A for displaying the training result of the machine learning model obtained in the second validation step and an area 154B for displaying the training result of the machine learning model obtained in the third validation step.

The first training result display area 151 is provided with a number-of-images display area 151a for displaying the number of training images used in the first training and the number of validation images used in the validation step, a Pareto diagram display area 151b, and an inference result display area 151c.

The Pareto diagram display area 151b displays a Pareto diagram generated by the processor 13c. The Pareto diagram is a separation graph illustrating the degree of separation between the non-defective class and the defective class, and is also a graph illustrating the accuracy of the determination of the machine learning model. The horizontal axis of this graph is the score (first evaluation axis), and the vertical axis is the cumulative number of images. A higher score indicates a higher degree of belonging to the defective class. In contrast, a lower score indicates a higher degree of belonging to the non-defective class. The score can also be referred to as a first evaluation value indicating the degree of belonging to the non-defective class. That is, in the classification of classifying the plurality of validation images into the non-defective class and the defective class, the processor 13c calculates the first evaluation value indicating the degree of belonging to the non-defective class for each of the plurality of validation images. As described above, since the score is also an evaluation value indicating the degree of defect, the processor 13c can calculate an evaluation value indicating the degree of defect for each of the plurality of validation images. This evaluation value can also be referred to as a second evaluation value indicating the degree of belonging to the defective class.

In the inference result display area 151c, an inference result by the machine learning model inspected in the validation step is displayed in a table format. The table displayed in the inference result display area 151c is also called a confusion matrix. This table displays the number of non-defective product images and the number of defective product images among the validation image, and together displays the number of non-defective product images and the number of defective product images inferred by the machine learning model. The processor 13c calculates an erroneous determination rate indicating the rate of detecting non-defective product images as defective product images and a missing rate indicating the rate of determining defective product images as non-defective product images, and causes the inference result display area 151c to display the calculated rates. The processor 13c also calculates the difference in score between the non-defective products and the defective products, and causes the inference result display area 151c to display the difference. In the example illustrated in

FIGS. 6 to 8, the validation images for each validation includes the training images used for training the machine learning model.

Next, the process proceeds to step SA3 of the flowchart illustrated in FIG. 4. Step SA3 is a step of determining whether the non-defective product images and the defective product images have been separated in the validation step of step SA2 according to a predetermined criterion, and evaluates the accuracy of the classification of the validation images and the accuracy of the determination of the validation images. That is, the score calculated in step SA2 is a numerical value indicating, for example, the size of the defect as the degree of defect in the validation image. In step SA3, the processor 13c obtains the difference between the maximum score in the case of being determined as a non-defective product (degree of defect: high) and the minimum score in the case of being determined as a defective product (degree of defect: low), and determines whether the difference is equal to or greater than a predetermined numerical value. If the difference is equal to or greater than the predetermined value, it is determined that the non-defective product images and the defective product images have been separated. If the difference is smaller than the predetermined value, it is determined that the non-defective product images and the defective product images have not been separated.

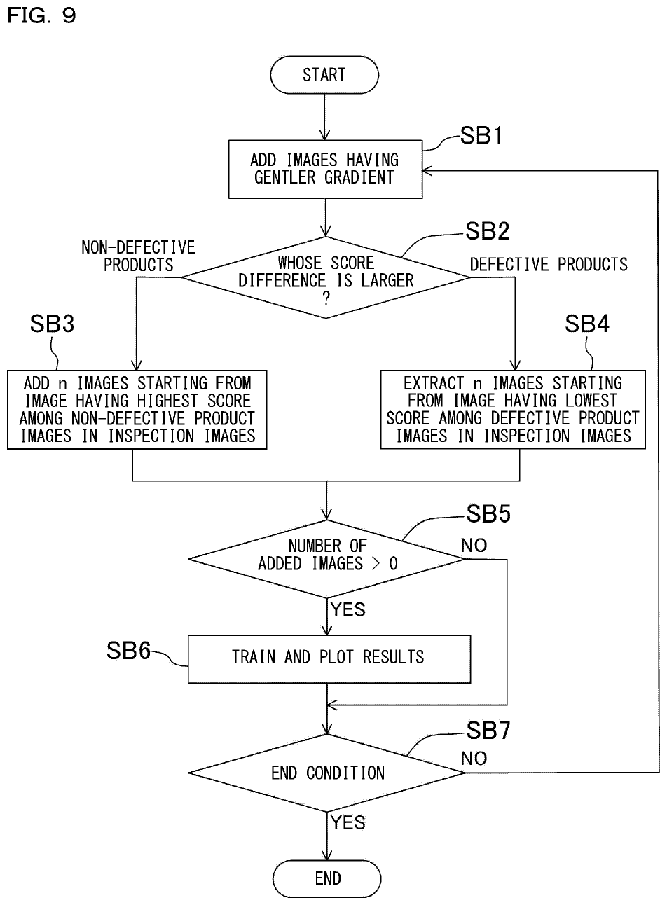

If it is determined in step SA3 that the non-defective product images and the defective product images have been separated, the process proceeds to step SA7 to determine whether the setting is to execute only the above-described step 1. That is, the user can set one for performing the automatic training between a first mode of ending the automatic training after the above-described step 1 alone and a second mode of executing both the above-described step 1 and step 2. The setting of the user is received by the input unit 13b. If the setting is to execute only the above-described step 1, the automatic training is ended. On the other hand, if the setting is to execute both the above-described step 1 and step 2, the process proceeds to the flowchart of step 2 illustrated in FIG. 9.

If it is determined in step SA3 that the non-defective product images and the defective product images have not been separated, the process proceeds to step SA4. In step SA4, the processor 13c determines whether one or more non-defective product images remain in the validation images. If one or more non-defective product images remain in the validation images, the process proceeds to step SA5. In step SA5, it is determined whether any non-defective product images are erroneously detected among the validation images.

If no any non-defective product images are erroneously detected among the validation images in step SA5, the process proceeds to step SA6. In step SA6, the processor 13c determines whether any non-defective product images among the validation images have a score higher than that of the erroneously determined defective product image. If no non-defective product images have a score higher than the defective product image erroneously determined in step SA6, the process proceeds to step SA7.

If any non-defective product images are erroneously detected among the validation images in step SA5, the process proceeds to step SA8. In step SA8, the processor 13c extracts n erroneously detected non-defective product images from among the validation images in descending order of score. n is an integer of 1 or more. Accordingly, the number of the non-defective product images extracted in step SA8 may be one, two or more. The number of images extracted in step SA8 can be the number of images described in a second example described later.

After the n non-defective product images are extracted in descending order of score in step SA8, the process proceeds to step SA2, and the n non-defective product images extracted in step SA8 are input to the machine learning model to automatically re-train the machine learning model. At this time, the processor 13c may execute so-called data expansion (augmentation) of rotating the image and/or changing the brightness of the image. For example, the processor 13c uses the image extracted in step SA8 to automatically generate an image in which the brightness is changed by 5%, and inputs the generated image to the machine learning model for training. If the training effect is low, the processor 13c also generates an image in which the brightness is changed by 10% stepwise or dynamically, and inputs the generated image to the machine learning model for training.

If any non-defective product images have a score higher than the defective product image erroneously determined in step SA6, the process proceeds to step SA9. In step SA9, n non-defective product images having a score higher than the erroneously determined defective product images are extracted in ascending order of score. n is an integer of 1 or more. Accordingly, the number of the non-defective product images extracted in step SA9 may be one, two or more. In this way, the processor 13c compares the scores as the evaluation values of the non-defective product images and the scores as the evaluation values of the defective product images among the plurality of validation images, and automatically determines, based on the comparison result, which of the non-defective product images having a relatively high evaluation value and the defective product images having a relatively low evaluation value is to be extracted as the images for re-training the machine learning model.

Although it can be considered to extract the defective product images having a low score from among the erroneously determined defective product images, since the purpose of the image inspection is to detect those other than non-defective products, the training with non-defective products is continued as much as possible to clarify the range of non-defective products. If the training with defective products is to be performed, a large number of defective product images are required to clarify the boundary between the non-defective product and the defective product. However, it is difficult to prepare a large amount of defective product images because the number of defective products is small in the first place.

After the n non-defective product images are extracted in ascending order of score in step SA9, the process proceeds to step SA2, and the n non-defective product images extracted in step SA9 are input to the machine learning model to automatically re-train the machine learning model. At this time, the processor 13c may execute so-called data expansion (augmentation) of rotating the image and/or changing the brightness of the image.

In step SA2, executed are inputting the plurality of validation images to the machine learning model after re-training and the classification of classifying the plurality of validation images into the plurality of classes. Thereafter, steps SA3 to SA7, and step SA8 and step SA9 as necessary, are executed.

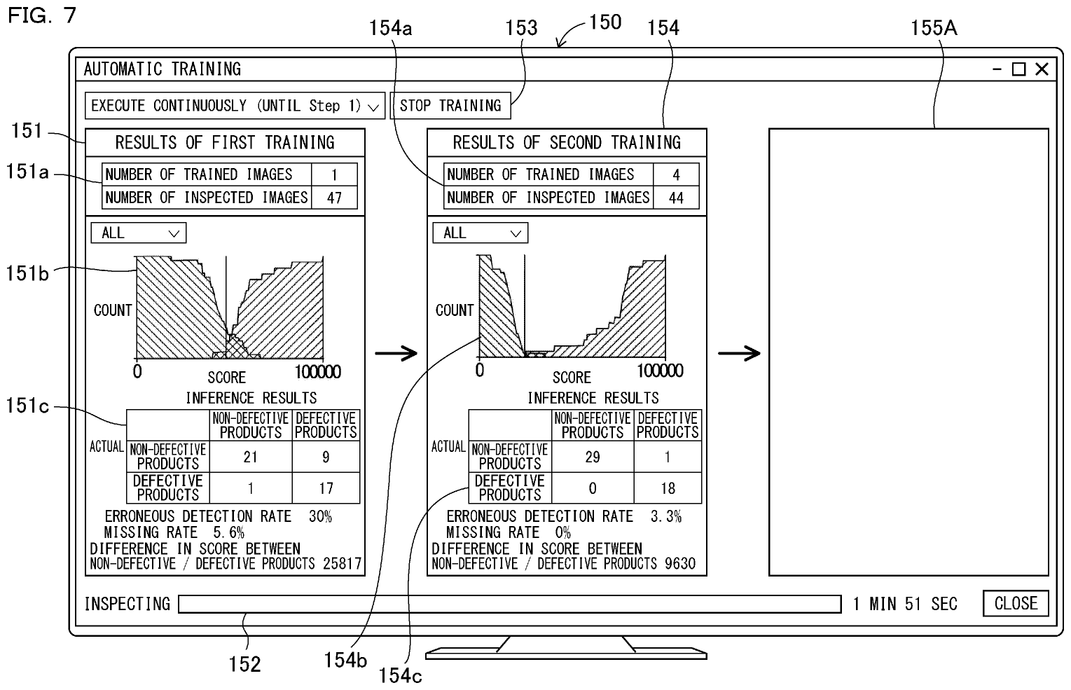

FIG. 7 illustrates a training result display user interface screen 150 for displaying a second training result display area 154 for displaying the training result of the machine learning model obtained in the second validation step after ending the second training (first re-training). The second training result display area 154 is generated and displayed by the processor 13c similarly to the first training result display area 151. The second training result display area 154 is provided with a number-of-images display area 154a for displaying the number of training images used in the second training and the number of validation images used in the validation step, a Pareto diagram display area 154b indicating the degree of separation obtained in the second validation step, and an inference result display area 154c obtained in the second validation step. Illustrated in FIG. 7 is the area 154B for displaying the training result of the machine learning model obtained in the third validation step.

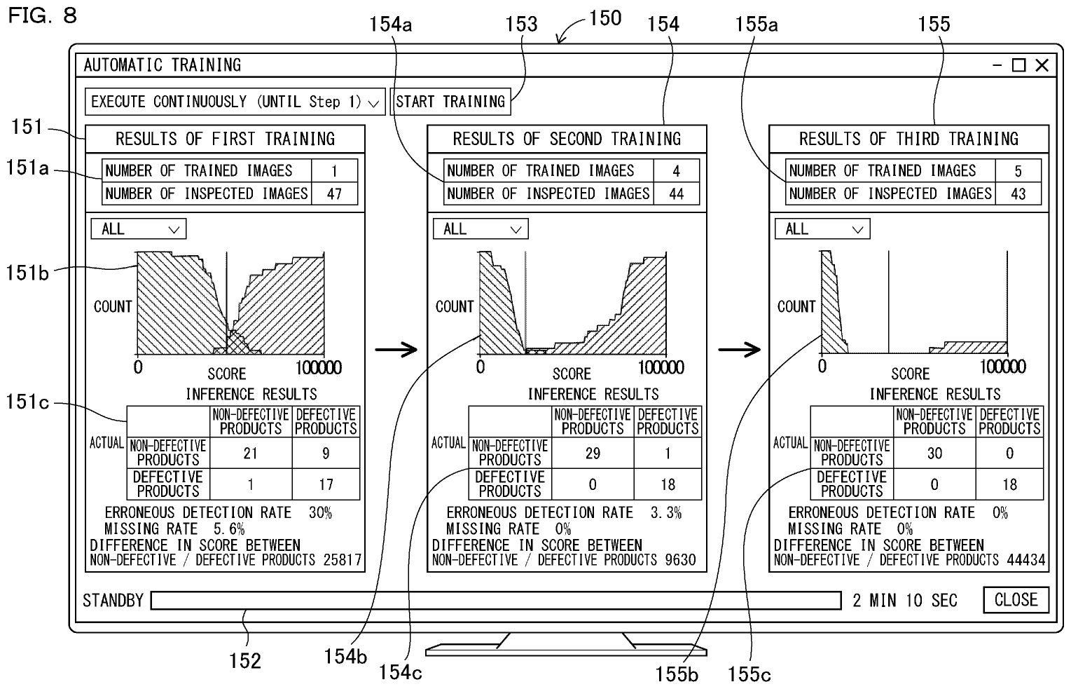

FIG. 8 illustrates a training result display user interface screen 150 for displaying a third training result display area 155 for displaying the training result of the machine learning model obtained in the third validation step after ending the third training (second re-training). The third training result display area 155 is generated and displayed by the processor 13c similarly to the first training result display area 151. The third training result display area 155 is provided with a number-of-images display area 155a for displaying the number of training images used in the third training and the number of validation images used in the validation step, a Pareto diagram display area 155b indicating the degree of separation obtained in the third validation step, and an inference result display area 155c obtained in the third validation step. Every time the re-training of the machine learning model is repeated, the processor 13c updates the separation graph illustrated as the Pareto diagram to the separation graph obtained by the machine learning model after the re-training. As illustrated in FIGS. 7 and 8, the processor 13c can generate the training result display user interface screen 150 as a display screen displaying the latest separation graph obtained by the update in a manner comparable with the past separation graph, and cause the display device 4 to display the user interface screen 150.

The training images overlap each other in each time. For example, if the number of training images for the second training is four, the four training images are included in five training images for the third training. That is, new training images are added as the number of trainings increases.

As illustrated in FIG. 8, as the number of trainings increases, the difference in score between the non-defective product and the defective product increases, and the separation between the non-defective product images and the defective product images becomes clearer. In the machine learning model after the third training is completed, the separation between the non-defective product images and the defective product images and the determination as to whether the image belongs to the non-defective class or the defective class can be performed clearly. Therefore, the automatic training is ended at the time point when the third training is completed. In this manner, the processor 13c automatically repeats, until it is evaluated that the re-training of the machine learning model is unnecessary: the classification of classifying the plurality of validation images by the trained machine learning model; the evaluation of the accuracy of the classification; the evaluation as to whether the re-training of the machine learning model is necessary; and the process of extracting the validation images whose classification result has a relatively high possibility to be erroneous from among the plurality of validation images to automatically re-train the machine learning model with the validation images if it is evaluated that re-training of the machine learning model is necessary. Accordingly, the accuracy of the machine learning model is improved, and the progress state is presented to the user as illustrated in FIG. 8.

After the degree of separation between the non-defective class and the defective class is obtained in the validation step of step SA2, through steps SA3 to SA6, the processor 13c evaluates the accuracy of the classification of the plurality of validation images based on the degree of separation between the non-defective class and the defective class obtained in step SA2, and further evaluates whether the re-training of the machine learning model is necessary based on the evaluation result of the accuracy of the classification of the plurality of validation images. If it is evaluated that re-training of the machine learning model is necessary, the processor 13c extracts the validation images whose classification result has a relatively high possibility to be erroneous from among the plurality of validation images to automatically re-train the machine learning model. On the other hand, if it is evaluated that the re-training of the machine learning model is unnecessary, the processor 13c completes the training of the machine learning model.

If it is evaluated that the re-training of the machine learning model is necessary, the processor 13c extracts the defective product images having a relatively high first evaluation value or the non-defective product images having a relatively low first evaluation value to automatically re-train the machine learning model. Moreover, the processor 13c extracts the non-defective product images having a relatively high evaluation value indicating the degree of defect or the defective product images having a relatively low evaluation value indicating the degree of defect to automatically re-train the machine learning model. As illustrated in FIG. 8, the processor 13c obtains the degree of separation of distribution between the non-defective product images and the defective product images on the horizontal axis of the Pareto diagram (first evaluation value). The processor 13c automatically repeats, until it is evaluated that the re-training of the machine learning model is unnecessary based on the obtained degree of separation: the classification of classifying the plurality of validation images by the trained machine learning model; the evaluation of the accuracy of the classification; the evaluation as to whether the re-training of the machine learning model is necessary; and the process of extracting the validation images whose classification result has a relatively high possibility to be erroneous from among the plurality of validation images to automatically re-train the machine learning model with the validation images if it is evaluated that re-training of the machine learning model is necessary. This repeated processing is executed by the processor 13c until the degree of separation of distribution between the non-defective product images and the defective product images on the horizontal axis of the Pareto diagram becomes equal to or greater than a predetermined value. The criterion for evaluating that the re-training of the machine learning model is unnecessary is not limited to the above-described specification determined based on the degree of separation. That is, assuming the case where the degree of separation is not equal to or greater than the predetermined value, it may be evaluated that the re-training of the machine learning model is unnecessary if the required time or number of times of repeating the above-described processing reaches a time or number of times designated in advance by the user or a time or number of times defined in advance on the device side. Whether the re-training is unnecessary may be evaluated based on an appropriate combination of the degree of separation and the time or number of times.

If a plurality of evaluation images are prepared, the processor 13c may evaluate that the re-training of the machine learning model is unnecessary. After completing the training of the machine learning model, the processor 13c may input the plurality of evaluation images different from the plurality of training images and the plurality of validation images to the machine learning model, execute classification of classifying the plurality of evaluation images into the plurality of classes (the non-defective class or the defective class), and evaluate the accuracy of the classification. The processor 13c may cause the display device 4 to display the accuracy rate as the accuracy of the classification of the plurality of evaluation images.

If the second evaluation value indicating the degree of belonging to the defective class is calculated for each of the plurality of validation images, if it is evaluated that the re-training of the machine learning model is necessary, the processor 13c extracts the non-defective product images having a relatively high second evaluation value or the defective product images having a relatively low second evaluation value to automatically re-train the machine learning model. The processor 13c obtains the degree of separation between the distribution of the non-defective product images and the distribution of the defective product images on the second evaluation value axis, and automatically repeats, until it is evaluated that the re-training of the machine learning model is unnecessary based on the degree of separation: the classification of classifying the plurality of validation images by the trained machine learning model; the evaluation of the accuracy of the classification; the evaluation as to whether the re-training of the machine learning model is necessary; and the process of extracting the validation images whose classification result has a relatively high possibility to be erroneous from among the plurality of validation images to automatically re-train the machine learning model with the validation images if it is evaluated that re-training of the machine learning model is necessary.

### First Example of Step 2

Next, the process of the above-described step 2 will be described with reference to the flowchart illustrated in FIG. 9. In step SB1, the non-defective class and the defective class are compared in a Pareto diagram, and the image of the one having the gentler gradient is added. For example, the processor 13c calculates the difference in score between the image having the highest score and the image having the second highest score among the images classified into the non-defective class, and calculates the difference in score between the image having the lowest score and the image having the second lowest score among the images classified into the defective class. If the two differences between the scores are the same, the processor 13c calculates the difference in score between the image having the highest score and the image having the third highest score among the images classified into the non-defective class, and calculates the difference in score between the image having the lowest score and the image having the third lowest score among the images classified into the defective class.

In step SB2, the processor 13c determines which of the two differences in score calculated in step SB1 is larger. If the difference in score of the images classified into the non-defective class is larger, the process proceeds to step SB3. If the difference in score of the images classified into the defective class is larger, the process proceeds to step SB4.

In step SB3, the processor 13c adds the n non-defective product images in order from the image having the highest score among the non-defective product images in the validation images. In step SB4, the processor 13c adds the n defective product images in order from the image having the lowest score among the defective product images in the validation images. After step SB3 and step SB4, the process proceeds to step SB5.

In step SB5, the processor 13c determines whether the number of images added in step SB3 or step SB4 is larger than 0. If it is determined as YES in step SB5, the process proceeds to step SB6, and the processor 13c executes the re-training as in step SA2 of the flowchart illustrated in FIG. 4, performs the validation with the validation images, and generates the Pareto diagram. If the process proceeds to step SB6 through step SB4, the processor 13c inputs the images belonging to the defective class to the machine learning model to re-train the machine learning model, and generates the machine learning model such that an image having features similar to the images belonging to the defective class is determined as an image belonging to the defective class. Thereafter, the process proceeds to step SB7 to determine whether an end condition is satisfied. The end condition will be described in a second example of step 2 described later.

### Second Example of Step 1

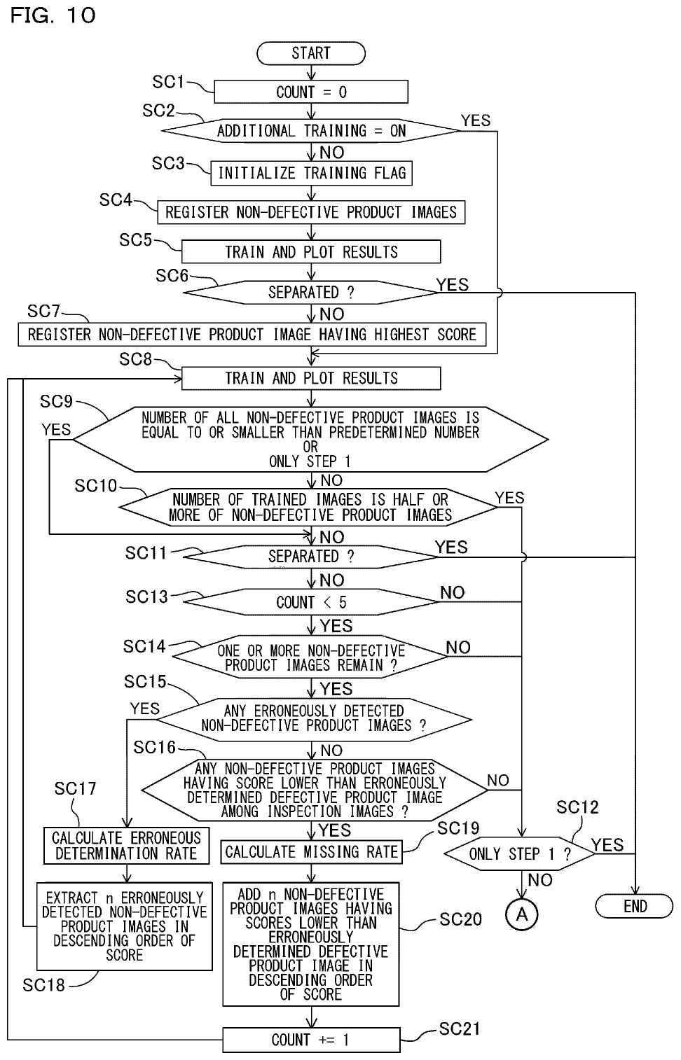

FIG. 10 is a flowchart illustrating a second example of step 1 of the automatic training. In step SC1, the processor 13c sets the count to 0. In step SC2, the processor 13c determines whether the additional training is ON. For example, new workpiece images can be acquired when the operation of the image processing device 1 is started to image the workpiece. If new workpiece images are collected, the processor 13c can select: a process of holding in advance the labels related to the classification of the existing training images and validation images used for the training of the machine learning model in operation and adding training images by adding the new images acquired after starting the operation to the existing training images (additional training); and a process of initializing the labels related to the classification of the existing training images and validation images used for the training of the machine learning model in operation and training the machine learning model with all the images including the new images acquired after starting the operation (all-image training). The labels include the non-defective label given to the non-defective product images and the defective label given to the defective product images. If the accuracy of the machine learning model in operation is high, the workpiece images are added without initialization, and if the accuracy is low, the workpiece images may be initialized and trained from the beginning to obtain higher accuracy. This enables proper use depending on the situation.

The image display user interface screen 100 illustrated in FIG. 5 is provided with a selection area 104 for selecting whether to enable the additional training. When the user operates the mouse 52 to check the selection area 104, the processor 13c executes the additional training. On the other hand, if the selection area 104 is not checked, the processor 13c executes the all-image training. Whether to select the additional training or the all-image training is determined by the processor 13c when the input unit 13b receives an operation on the mouse 52 by the user. That is, the image processing device 1 is configured to receive the selection by the user of the additional training or the selection by the user of the all-image training.

If it is determined as NO in step SC2 and the additional training is not selected, the process proceeds to step SC3. In step SC3, the processor 13c initializes the labels related to the classification of the existing training images and validation images. In step SC4, the processor 13c registers only one non-defective product image as a training image. At this time, the non-defective product image positioned at the head may be selected and registered, or another non-defective product image may be registered.

In step SC5 and step SC6, the processes of step SA2 and step SA3 of the flowchart illustrated in FIG. 4 are executed, respectively. If it is determined in step SC6 that the non-defective product images and the defective product images have been separated from each other, this means that the accuracy of the determination is sufficiently high and a predetermined accuracy is obtained. In this case, the flow is ended. That is, if it is evaluated that the accuracy of the determination of the machine learning model has acquired a predetermined accuracy, the processor 13c automatically determines to end the training of the machine learning model.

If it is determined to end the training of the machine learning model, the processor 13c automatically generates a graph of the Pareto diagram on the training result display user interface screen 150 illustrated in FIGS. 6 to 8, and causes the display device 4 to display the graph. Moreover, if it is determined to end the training of the machine learning model, the processor 13c automatically generates a numerical value indicating the accuracy of the determination of the machine learning model, for example, the difference in score between the non-defective products and the defective products, and causes the display device 4 to display the numerical value. Accordingly, the accuracy of the determination acquired when the training is ended can be presented to the user.

As illustrated in FIGS. 6 to 8, the training result display user interface screen 150 includes the number-of-images display areas 151a, 154a, and 155a for displaying the number of non-defective product images and the number of defective product images for training the machine learning model, and the inference result display areas 151c, 154c, and 155c for displaying the number of erroneously determined images for the plurality of validation images. Accordingly, it is possible to present the number of training images and the number of erroneously determined images to the user.

If it is determined in step SC6 that the non-defective product images and the defective product images have not been separated, the process proceeds to step SC7. In step SC7, the processor 13c registers the non-defective product image having the highest score among the validation images as a training image. Thereafter, the process proceeds to step SC8 to execute the same process as step SC5.

In step SC9, the processor 13c determines whether the number of all non-defective product images is equal to or less than a predetermined number (for example, 20), or whether the setting is to execute only the above-described step 1. If the number of all non-defective product images exceeds the predetermined number, the process proceeds to step SC10. Alternatively, if the setting is to execute the above-described step 1 and step 2, the process proceeds to step SC10. On the other hand, if the number of all non-defective product images is equal to or less than the predetermined number, the process proceeds to step SC11. Alternatively, if the setting is to execute only the above-described step 1, the process proceeds to step SC11.

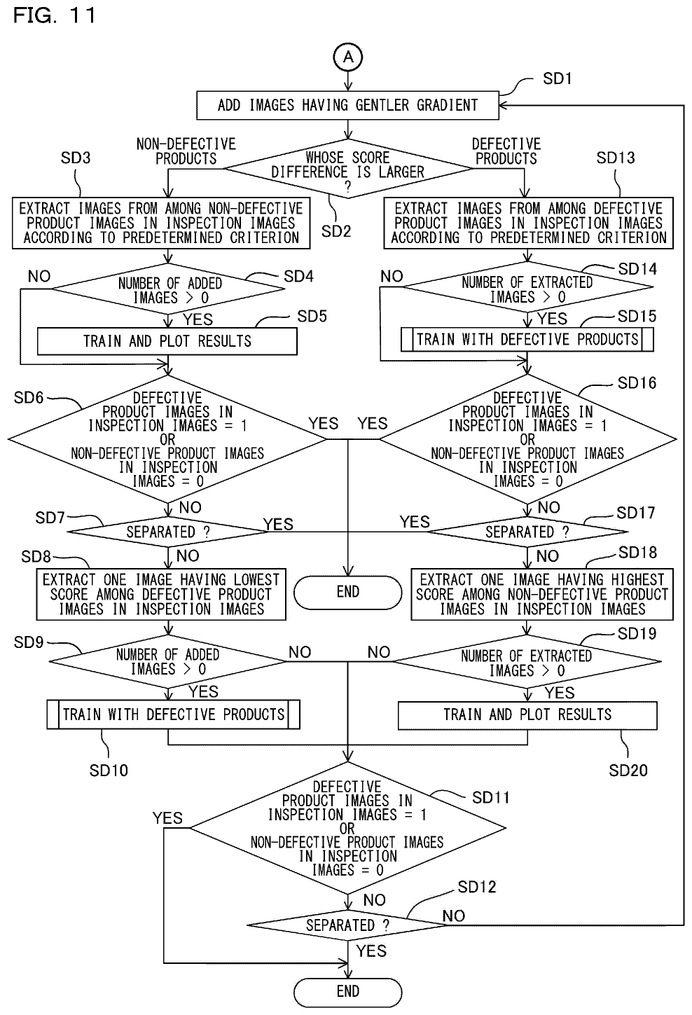

In step SC10, the processor 13c determines whether the total number of training images is half or more of the non-defective product images. If the total number of training images is half or more of the number of non-defective product images, the process proceeds to step SC12. In step SC12, similarly to step SA7 of the flowchart illustrated in FIG. 4, it is determined whether the setting is to execute only the above-described step 1. If the setting is to execute only the above-described step 1, the automatic training is ended. On the other hand, if the setting is to execute both the above-described step 1 and step 2, the process proceeds to the flowchart of step 2 illustrated in FIG. 11.

If it is determined in step SC10 that the total number of training images is less than half the number of non-defective product images, the process proceeds to step SC11. In step SC11, similarly to step SA3 of the flowchart illustrated in FIG. 4, it is determined whether the non-defective product images and the defective product images have been separated according to a predetermined criterion. If it is determined in step SA3 that the non-defective product images and the defective product images have been separated, the automatic training is automatically ended.

If it is determined in step SC11 that the non-defective product images and the defective product images have not been separated, the process proceeds to step SC13. In step SC13, the processor 13c determines whether the count is smaller than a predetermined value (for example, 5). If the count is equal to or greater than the predetermined value, the process proceeds to step SC12. If the count is smaller than the predetermined value, the process proceeds to step SC14.

In step SC14 and step SC15, the same determination as in step SA4 and step SA5 of the flowchart illustrated in FIG. 4 is performed. If it is determined as NO in step SC14, the process proceeds to step SC12. If it is determined as NO in step SC15, the process proceeds to step SC16. If it is determined as YES in step SC15 and any non-defective product images are erroneously detected among the validation images, the process proceeds to step SC17. In step SC17, the erroneous determination rate is calculated. The erroneous determination rate is an erroneous determination rate for non-defective product images among the plurality of validation images, and can be calculated by the following equation.

$$Erroneous determination rate = ( number of non - defective product images determined as \\ defective product images among validation images and training \\ images / total number of non - defective product images ) \times 100$$

After the erroneous determination rate is calculated in step SC17, the process proceeds to step SC18. In step SC18, similarly to step SA8 of the flowchart illustrated in FIG. 4, n erroneously detected non-defective product images are extracted from among the validation images in descending order of score. The number of images to be extracted may be changed according to the erroneous determination rate. For example, the number of images extracted in step SC18 can be set to increase as the erroneous determination rate increases. The number of images to be extracted in step SC18 can also be determined according to the ratio, for example, the number of images corresponding to 5%, 10%, or 15% with respect to all the non-defective product images. In this manner, the processor 13c determines the number of non-defective product images to be used for re-training of the machine learning model based on the erroneous determination rate for the non-defective product images among the plurality of validation images.

After the n non-defective product images are extracted in descending order of score in step SC18, the process proceeds to step SC8, and the n non-defective product images extracted in step SC18 are input to the machine learning model to automatically re-train the machine learning model.

Proceeding to step SC19 after determining as YES in step SC16, the missing rate is calculated. The missing rate is an erroneous determination rate for defective product images among the plurality of validation images, and can be calculated by the following equation.

$$Missing rate = ( number of defective product images determined as non - defective \\ product images among validation images and training \\ images / total number of defective product images ) \times 100$$

After the missing rate is calculated in step SC19, the process proceeds to step SC20. In step SC20, similarly to step SA9 of the flowchart illustrated in FIG. 4, n non-defective product images having a score higher than the erroneously determined defective product images are extracted in ascending order of score. The number of images to be extracted may be changed according to the missing rate. For example, the number of images extracted in step SC20 can be set to increase as the missing rate increases. The number of images to be extracted in step SC20 can also be determined according to the ratio, for example, the number of images corresponding to 5%, 10%, or 15% with respect to all the non-defective product images. In this manner, the processor 13c determines the number of defective product images to be used for re-training of the machine learning model based on the missing rate which is the erroneous determination rate for the defective product images among the plurality of validation images. The number of images extracted in step SC20 may be set larger than the number of images extracted in step SC18.

After step SC20, the process proceeds to step SC21, and the processor 13c adds 1 to the count. This count is used in the determination of the next step SC13. When the re-training is performed plural times through the steps SC16 to SC20 plural times, it is determined as NO in step SC13, the process proceeds to step SC12, and the above-described step 2 is started. That is, after the re-training based on the non-defective product image is repeated plural times, the above-described step 2 is automatically executed if the processor 13c evaluates that further re-training of the machine learning model is required. The processor 13c may end the training after step 1 alone, or the user may be allowed to shift to the above-described step 2 at any time point.

After step SC21, the process proceeds to step SC8, and the n defective product images extracted in step SC20 are input to the machine learning model to automatically re-train the machine learning model.

As described above, if it is evaluated in step SC15 that the re-training of the machine learning model is necessary, in step SC18 and step SC20, the processor 13c automatically calculates the number of validation images to be used for re-training based on the evaluation result of the accuracy of the classification, and extracts the validation images whose classification result has a relatively high possibility to be erroneous by the calculated number from among the plurality of validation images. After extracting the validation images whose classification result has a relatively high possibility to be erroneous, the processor 13c can automatically re-train the machine learning model with validation images of the corresponding number. Thus, the burden on the user can be reduced.

### Second Example of Step 2

FIG. 11 is a flowchart illustrating a second example of step 2 of the automatic training. In step SD1 and step SD2, the same processing as in step SB1 and step SB2 of the flowchart illustrated in FIG. 9 is executed. If the difference in score of the images classified into the non-defective class is larger, the process proceeds to step SD3. In step SD3, the non-defective product images are extracted according to a predetermined criterion. Specifically, the processor 13c first identifies the image having the highest score among the non-defective product images in the validation images. Next, the processor 13c calculates a score by subtracting 10% from the score of the identified image. Thereafter, the processor 13c adds the non-defective product images having a score equal to or greater than the calculated score up to the maximum number of images that can be added (for example, five).

In step SD4, the processor 13c determines whether the number of non-defective product images added in step SD3 is one or more. If the number of non-defective product images added in step SD3 is one or more, the process proceeds to step SD5, and the processor 13c executes the re-training as in step SB6 of the flowchart illustrated in FIG. 9, performs the validation with the validation images, and generates the Pareto diagram. On the other hand, if the number of non-defective product images added in step SD3 is 0, the re-training cannot be performed, and thus the process proceeds to step SD6 without passing through step SD5.

In step SD6, the processor 13c determines whether the number of defective product images among the validation images is 1 and whether the number of non-defective product images among the validation images is 0. As a result of the determination in step SD6, if the number of defective product images of the validation image is 1, the training is automatically ended, and if the number of non-defective product images of the validation image is 0, the training is automatically ended. On the other hand, as a result of the determination in step SD6, if the number of defective product images of the validation image is a number other than one, the process proceeds to step SD7, and if the number of non-defective product images of the validation image is one or more, the process proceeds to step SD7.

In step SD7, the process of step SA3 of the flowchart illustrated in FIG. 4 is executed. If it is determined in step SD7 that the non-defective product images and the defective product images have been separated, the training is automatically ended. If it is determined in step SD7 that the non-defective product images and the defective product images have not been separated, the process proceeds to step SD8. In step SD8, the processor 13c extracts one image having the lowest score among the defective product images in the validation images.

In step SD9, it is determined whether the number of defective product images added in step SD8 is one or more. If the number of defective product images added in step SD8 is one or more, the process proceeds to step SD10 to execute the training with defective products described later.

If the number of defective product images added in step SD8 is 0, the process proceeds to step SD11 to perform the same determination as in step SD6. As a result of the determination in step SD11, if the number of defective product images of the validation image is 1, the training is automatically ended, and if the number of non-defective product images of the validation image is 0, the training is automatically ended. On the other hand, as a result of the determination in step SD11, if the number of defective product images of the validation image is a number other than one, the process proceeds to step SD12, and if the number of non-defective product images of the validation image is one or more, the process proceeds to step SD12. In step SD12, the same processing as in step SD7 is executed.

As a result of the determination in step SD2, if the difference in score of the images classified into the defective class is larger, the process proceeds to step SD13. In step SD13, the defective product images are extracted according to a predetermined criterion. Specifically, the processor 13c first identifies the image having the lowest score among the defective product images in the validation images. Next, the processor 13c calculates a score by adding 10% to the score of the identified image. Thereafter, the processor 13c extracts defective product images having a score equal to or less than the calculated score up to the maximum number of images that can be added (for example, five). However, if the number of defective product images of the validation image is five or less, only one defective product image is left instead of using all the defective product images for the training with defective products.

In step SD14, the processor 13c determines whether the number of defective product images extracted in step SD13 is one or more. If the number of defective product images extracted in step SD13 is one or more, the process proceeds to step SD15 to execute the training with defective products described later. On the other hand, if the number of defective product images extracted in step SD13 is 0, the process proceeds to step SD16 without passing through step SD15.

In step SD16 and step SD17, the same determination as in step SD6 and step SD7 is performed. In the subsequent step SD18, the processor 13c adds one image having the highest score among the non-defective product images in the validation images.

In step SD19, it is determined whether the number of non-defective product images added in step SD18 is one or more. If the number of non-defective product images added in step SD18 is one or more, the process proceeds to step SD20 to execute the same processing as step SD5.

If the number of non-defective product images added in step SD18 is 0, the process proceeds to step SD20 to execute the same processing as step SD5. Thereafter, the process proceeds to step SD11 and step SD12.

According to the flowchart illustrated in FIG. 11, if it is evaluated that the re-training of the machine learning model is necessary, the processor 13c not only trains the machine learning model with the defective product images in step SD10 and step SD15, but also re-trains the machine learning model together with the non-defective product images in step SD5 and step SD20. Accordingly, it is possible to generate the machine learning model such that the features similar to the defective product images for training the machine learning model in step SD10 and step SD15 and the features different from the non-defective product images for training in step SD5 and step SD20 are determined as defective locations.

According to the flowchart illustrated in FIG. 11, if it is evaluated that the re-training of the machine learning model is necessary in the determination of determining the class to which the image belongs, the processor 13c can automatically determine whether the non-defective product images or the defective product images are to be used for training the machine learning model by comparing the evaluation value of the non-defective product images and the evaluation value of the defective product images, and train the machine learning model with the images having a higher training effect.

### Training with Defective Products

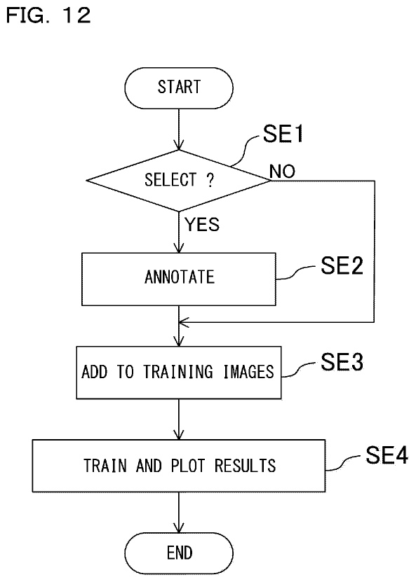

FIG. 12 is a flowchart illustrating an example of the training with defective products. This flow is executed in step SD10 and step SD15 of the flowchart illustrated in FIG. 11, and steps SE1 to SE3 are repeated for the number of extracted defective product images.

In step SE1, it is determined whether the user selects the area designation for the defective product images in the above-described step 2, that is, whether the user designates the defective locations for the defective product images (whether to annotate). If the user selects the area designation, the process proceeds to step SE2, and the input unit 13b receives the annotation operation by the user.

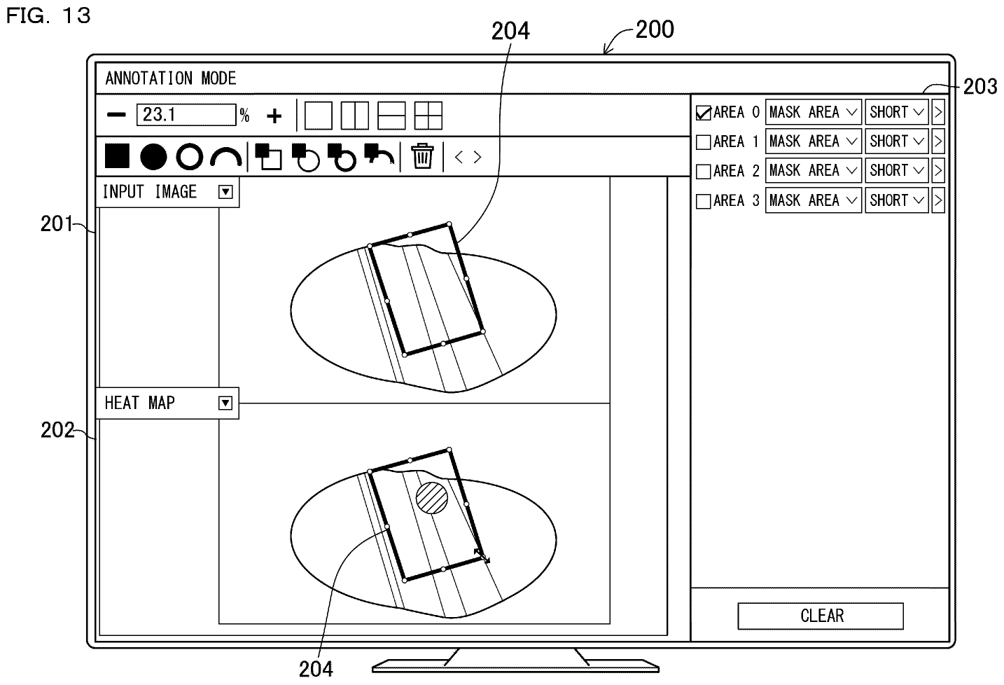

Specifically, the processor 13c extracts the defective product images as the images for re-training the machine learning model from among the plurality of validation images, generates an annotation screen 200 illustrated in FIG. 13 as a display screen for receiving the designation of the defective locations in the defective product images from the user, and causes the display device 4 to display the annotation screen 200. The annotation screen 200 is automatically displayed when the process proceeds to step SE2.

The annotation screen 200 is provided with an input image display area 201 for displaying an input image input to the machine learning model, a heat map display area 202 for displaying a heat map output from the machine learning model, and an area designation section 203. The input image displayed in the input image display area 201 corresponds to the heat map displayed in the heat map display area 202. The scale of the input image and the scale of the heat map are the same, and the same area is displayed. As illustrated in the drawing, by providing a user interface capable of displaying the input image and the heat map side by side, it becomes easy to grasp the corresponding portions of both. The heat map display area 202 may be displayed as necessary, and may be omitted.

The heat map is an image that emphasizes a characteristic portion different from the non-defective product image mores than the other portions by a difference in color or brightness. That is, the processor 13c can identify a feature portion different from the previously trained non-defective product images with respect to the defective product images extracted for re-training the machine learning model from among the plurality of validation images, and then generate the annotation screen 200 including the heat map as an image that emphasizes the identified different feature portion in the extracted defective product images, and cause the display device 4 to display the annotation screen 200.

The input image displayed in the input image display area 201 is a defective product image extracted for re-training the machine learning model from among the plurality of validation images. However, the input image displayed in the input image display area 201 alone may not sufficient for grasping the area to which the machine learning model reacts. In this example, since the heat map which emphasizes the identified different characteristic portion is also displayed at the same time, the user can view the heat map to grasp the area to which the machine learning model reacts as a defective location and the strength of the reaction.

In the area designation section 203, a plurality of areas, for example, “area 0”, “area 1”, “area 2” and “area 3” can be designated. If a mask area is designated as “area 0”, the shape of the designated area can be selected. Examples of the shape include a rectangle, a circle, and a polygon, and the user can select the shape by operating the mouse 52 or the like. The selected shape is received by the input unit 13b, and the processor 13c displays a frame 204 having the same shape as the selected shape in a manner superimposed on both the input image and the heat map.

The frame 204 is used to designate the defective location. The position, size, angle, aspect ratio, and the like of the frame 204 can be changed by the user operating the mouse 52 or the like. The area surrounded by the frame 204 can be designated as the defective location by the user moving the frame 204 to surround the defective location or changing the size of the frame 204. Both the frame 204 on the input image and the frame 204 on the heat map can be operated. If the frame 204 on the input image is operated, the operation is reflected in the frame 204 on the heat map, and the two frames 204 are adjusted to the same size and arranged at the same position. If the frame 204 on the heat map is operated, the operation is reflected in the frame 204 on the input image.

In order to increase the difference in score between the non-defective products and the defective products, a plurality of defective product images may be required. If a plurality of defective product images are required, the defective product images are displayed sequentially, and the defective product images can be annotated sequentially. For example, the annotation is executed in a state in which the first defective product image is displayed, and when ended, the second defective product image is automatically displayed and the annotation can be received.

The designation of the defective location is received by the input unit 13b. When the designation of the defective location is received by the input unit 13b, the processor 13c identifies the area surrounded by the frame 204 as the defective location, and stores the defective location in, for example, the storage device 19. In step SE3, the processor 13c adds the defective product image in which the defective location is identified to the training image through the annotation screen 200. In step SE4, the machine learning model is re-trained to generate a machine learning model such that an image having features similar to the defective location is determined as an image belonging to the defective class.

The processor 13c is configured to restart the re-training of the machine learning model in response to a user instruction even after completing the training of the machine learning model. For example, the training result display user interface screen 150 illustrated in FIG. 5 is provided with a train button 105. The operation on the train button 105 by the user is a user instruction to restart re-training of the machine learning model. This user instruction is received by the processor 13c.

When the instruction to re-train the machine learning model is received, the processor 13c inputs new validation images different from the existing validation images to the machine learning model and executes the process of classifying the new validation image into the plurality of classes. For example, a plurality of workpiece images can be acquired after the operation of the image processing device 1 is started. These workpiece images can be the new validation images. The processor 13c evaluates the accuracy of the classification based on the degree of separation between the plurality of classes obtained by the classification for the new validation images. If it is evaluated that the re-training of the machine learning model is necessary based on the evaluation result of the accuracy of the classification, the processor 13c extracts the validation images whose classification result has a high possibility to be erroneous from among the new validation images to automatically re-train the machine learning model. On the other hand, if it is evaluated that the re-training of the machine learning model is unnecessary, the processor completes the training of the machine learning model. Accordingly, even if a new image is acquired after the training is once completed, it is possible to re-train the existing machine learning model according to the user instruction, which can continuously improve the accuracy of the machine learning model.

### Learning Model Selection Function

The accuracy of the machine learning model changes if the re-training of the machine learning model is repeated. FIG. 6 illustrates the accuracy of the machine learning model whose first training is ended, and the accuracy of the machine learning model is improved as illustrated in FIG. 8 as the number of trainings increases to the second and third times. Based on the time point at which the third training is finished, the third training is the latest re-training, and the separation graph obtained by the latest re-training is displayed in the Pareto diagram display area 155b in FIG. 8. The training stages before the training stage in which the latest separation graph is obtained are the first training stage and the second training stage, and the separation graph obtained in the first training stage and the separation graph obtained in the second training stage are the past separation graphs relative to the separation graph obtained in the third training. That is, the processor 13c generates the training result display user interface screen 150 illustrated in FIGS. 7 and 8 as a display screen displaying, in a comparable manner, the latest separation graph obtained by repeatedly re-training the machine learning model and the past separation graphs obtained in the training stages before the training stage in which the latest separation graph is obtained, and causes the display device 4 to display the user interface screen 150. FIG. 8 illustrates only up to the third training, but the number of trainings is not particularly limited, and the training may be repeated until the desired accuracy is obtained.

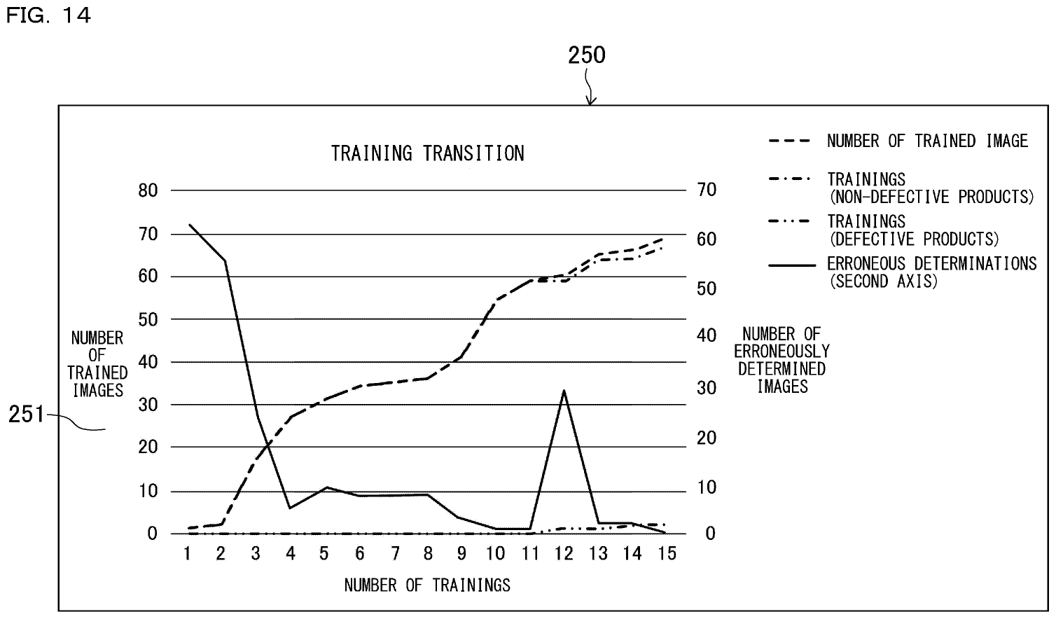

FIG. 14 illustrates an example of a training transition display screen 250 for presenting the transition of the accuracy of the machine learning model. The training transition display screen 250 can be incorporated into the training result display user interface screen 150 illustrated in FIGS. 6 to 8 and displayed together with the Pareto diagram and the like. Since the training transition graph indicates the progress of training of the machine learning model, the user can predict the number of trainings to obtain a machine learning model having the desired accuracy by viewing the training transition graph.

The training transition display screen 250 is provided with a graph display area 251 for displaying the training transition graph. The horizontal axis of the training transition graph is the number of trainings, and in this example, the number of trainings is up to 15. The left vertical axis represents the number of trained images, and the right vertical axis represents the number of images erroneously determined by the machine learning model. As illustrated in the training transition graph, the accuracy improvement of the machine learning model is remarkable from the first through the fourth training, but the degree of accuracy improvement is low from the fifth training, and the twelfth machine learning model has more erroneous determinations as compared with the eleventh and thirteenth trainings. As described above, the accuracy is not always improved by increasing the number of trainings, and the accuracy may suddenly decrease depending on the images used for training. By displaying the training transition graph, the user can grasp a sudden decrease in accuracy, and can thereby avoid the corresponding machine learning model and select to use a machine learning model of another training with high accuracy in operation. This function is referred to as the learning model selection function.

Specifically, the processor 13c is configured to receive as the machine learning model used in operation, from the user, the selection of a past machine learning model corresponding to a past separation graph, in addition to the latest machine learning model corresponding to the latest separation graph. For example, if the numerical value on the horizontal axis of the training transition graph (the number of trainings) illustrated in FIG. 14 is designated by the mouse 52 or the like, the selection of the machine learning model corresponding to the separation graph of the designated number of trainings is received by the processor 13c. The “machine learning model corresponding to the separation graph of the designated number of trainings” is the machine learning model when the separation graph of the designated number of trainings is obtained.

When the selection of the past machine learning model is received, the processor 13c identifies all the training images for training the selected past machine learning model. The training images for training the past machine learning model can be stored in the storage device 19 or the like as training information. By reading the training information, the processor 13c can acquire the training images for training the machine learning model in each training.

After identifying all the training images for training the selected past machine learning model, the processor 13c trains the machine learning model in the initial state before the start of training with all the identified training images, thereby reproducing the selected past machine learning model. Accordingly, if the accuracy of the classification is higher in a past machine learning model in the training stages before the latest machine learning model in which re-training is repeated, the past machine learning model can be easily reproduced and used for the operation.

To reproduce the past machine learning model, it is possible to either inherit or not inherit the machine learning model trained so far. If the machine learning model trained so far is not to be inherited, all the identified training images are used to train the machine learning model in the initial state. For example, if it is desired to reproduce the third machine learning model illustrated in FIG. 8, the machine learning model obtained in the second training is not inherited, and the accumulated five training images are input to the machine learning model in the initial state to train the machine learning model.

On the other hand, if the trained machine learning model is to be inherited, the model obtained in the previous training is trained with only the images newly added from the previous training. For example, if it is desired to reproduce the third machine learning model illustrated in FIG. 8, the machine learning model obtained in the second training is trained with only the one training image added from the second training to the third training. If the machine learning model trained so far is to be inherited, the training does not start from the initial state, so that the total training time until the automatic training is completed can be shortened.

### Three-Class Classification

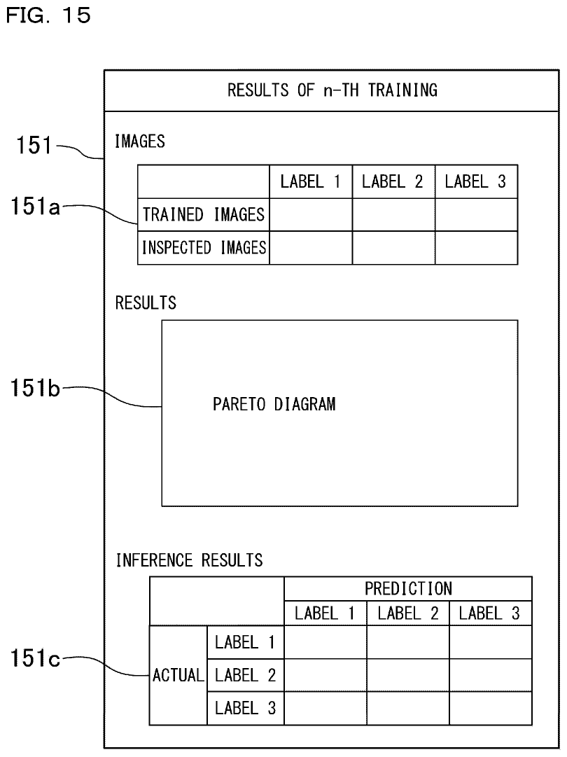

FIG. 15 is a diagram illustrating an example of the training result display area if the machine learning model performs three-class classification. The number-of-images display area 151a displays the number of images given the label 1, the number of images given the label 2, and the number of images given the label 3. The inference result display area 151c is provided with the columns of label 1, label 2, and label 3 for each of actual and prediction. Accordingly, the training result in the case of performing the three-class classification can also be presented to the user.

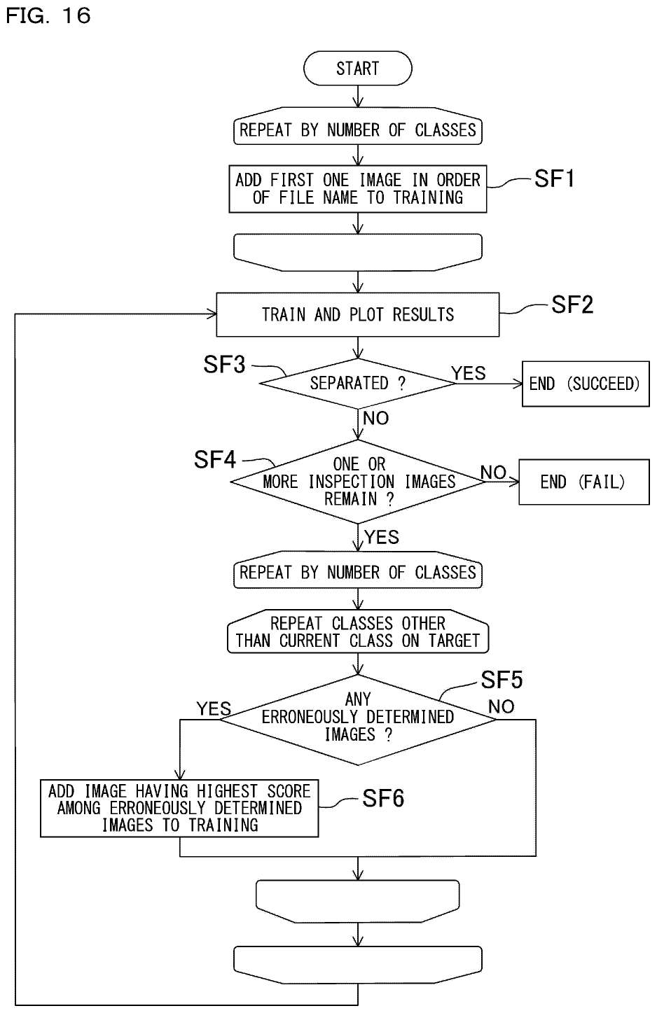

The details are illustrated in the flowchart of FIG. 16. In step SF1, the first image (in order of file name) of each class is added to the training images. After repeating this process by the number of classes, in step SF2, the added images are input to the machine learning model for training and then inspecting the machine learning model. As a result of the validation, if separated, it is determined as YES in step SF3, and the process is ended. If not separated, it is determined as NO in step SF3, and the process proceeds to step SF4. In step SF4, it is determined whether one or more validation images remain. If not one or more validation images remain, the process is ended. If one or more validation images remain, the process proceeds to step SF5. In step SF5, it is determined whether any images are erroneously determined for all the classes. If any images are erroneously determined in a class, the one image having the highest score in the class is added to the training images. If any images are erroneously determined in a plurality of classes, the one image having the highest score in each class is added to the training images (step SF6). The addition is not performed for the classes without any erroneously determined images. Thereafter, the process proceeds to step SF2, and the added images are input to the machine learning model for training and then inspecting the machine learning model.

The above-described embodiment is merely an example in all respects, and should not be construed in a limited manner. Further, modifications and changes belonging to an equivalent scope of the claims are all within the scope of the present invention.

### INDUSTRIAL APPLICABILITY

As described above, the image processing device and the image processing method according to the present disclosure can be used, for example, to perform appearance inspection of an industrial product.

What is claimed is:

1. An image processing device comprising a processor configured to input an image to a machine learning model and execute classification of classifying the image into a plurality of classes, wherein
the processor:
(1) trains the machine learning model with a plurality of training images;
(2) inputs a plurality of validation images to the machine learning model trained with the plurality of training images, and executes classification of classifying the plurality of validation images into the plurality of classes;
(3) obtains a degree of separation between the plurality of classes by the classification of the plurality of validation images and evaluates accuracy of the classification of the plurality of validation images based on the obtained degree of separation between the plurality of classes; and
(4) evaluates whether re-training of the machine learning model is necessary based on an evaluation result of the accuracy of classification of the plurality of validation images,
extracts an validation image whose classification result has a relatively high possibility to be erroneous from among the plurality of validation images to automatically re-train the machine learning model if it is evaluated that the re-training of the machine learning model is necessary, and
completes the training of the machine learning model if it is evaluated that the re-training of the machine learning model is unnecessary.

2. The image processing device according to claim 1, wherein
the processor automatically repeats the processing of (2) to (4) until it is evaluated that the re-training of the machine learning model is unnecessary.

3. The image processing device according to claim 2, wherein
the plurality of classes include a first class and a second class,
the plurality of validation images include a first-class image given a label indicating the first class and a second-class image given a label indicating the second class,
the processor calculates a first evaluation value indicating a degree of belonging to the first class for each of the plurality of validation images in the classification of classifying the plurality of validation images into the first class and the second class, and if it is evaluated that the re-training of the machine learning model is necessary, the processor
extracts the second-class image having a relatively high first evaluation value or the first-class image having a relatively low first evaluation value to automatically re-train the machine learning model,
obtains a degree of separation of distribution between the first-class image and the second-class image on a first evaluation value axis, and
repeats the processing of (2) to (4) until it is evaluated that the re-training of the machine learning model is unnecessary based on the degree of separation.

4. The image processing device according to claim 3, wherein
the processor repeats the processing of (2) to (4) until the degree of separation of distribution between the first-class image and the second-class image on the first evaluation value axis becomes equal to or greater than a predetermined value.

5. The image processing device according to claim 2, wherein
the plurality of validation images include a non-defective product image given a non-defective label and a defective product image given a defective label,
the processor calculates an evaluation value indicating a degree of defect for each of the plurality of validation images in the classification, and
if it is evaluated that the re-training of the machine learning model is necessary, the processor
extracts a non-defective product image having a relatively high evaluation value or a defective product image having a relatively low evaluation value to automatically re-train the machine learning model,
obtains a degree of separation of distribution between the non-defective product image and the defective product image on an evaluation value axis, and
repeats the processing of (2) to (4) until the degree of separation becomes equal to or greater than a predetermined value.

6. The image processing device according to claim 5, wherein
the processor automatically determines which of the non-defective product image having a relatively high evaluation value and the defective product image having a relatively low evaluation value is to be extracted as an image for re-training the machine learning model based on a result of comparison between the evaluation value of the non-defective product image and the evaluation value of the defective product image among the plurality of validation images.

7. The image processing device according to claim 3, wherein
the processor further calculates a second evaluation value indicating a degree of belonging to the second class for each of the plurality of validation images in the classification, and
if it is evaluated that the re-training of the machine learning model is necessary, the processor
extracts the first-class image having a relatively high second evaluation value or the second-class image having a relatively low second evaluation value to automatically re-train the machine learning model,
obtains a degree of separation between distributions of the first-class image and the second-class image on a second evaluation value axis, and
repeats the processing of (2) to (4) until it is evaluated that the re-training of the machine learning model is unnecessary based on the degree of separation.

8. The image processing device according to claim 1, wherein
if it is evaluated that the re-training of the machine learning model is necessary, the processor
automatically calculates the number of validation images used for re-training based on an evaluation result of the accuracy of the classification, and
extracts the validation images whose classification result has a relatively high possibility to be erroneous by the calculated number from among the plurality of validation images to automatically re-train the machine learning model with the validation images of the corresponding number.

9. The image processing device according to claim 8, wherein
if it is evaluated that the re-training of the machine learning model is necessary, the processor extracts the validation images by the calculated number from among the plurality of validation images in relatively descending order of possibility of the classification result being erroneous to automatically re-train the machine learning model with the validation images of the corresponding number.

10. The image processing device according to claim 3, wherein
the processor
generates a display screen including a separation graph indicating the degree of separation of the distribution between the first-class image and the second-class image on the first evaluation value axis and causes a display unit to display the display screen after executing the classification, and
updates the separation graph to the separation graph obtained by the machine learning model after the re-training, generates a display screen displaying a latest separation graph obtained by the update in a manner comparable to a past separation graph, and causes the display unit to display the display screen every time the re-training of the machine learning model is repeated.

11. The image processing device according to claim 10, wherein
the processor is configured to
generate a display screen displaying, in a comparable manner, a latest separation graph obtained by repeatedly re-training the machine learning model and a past separation graph obtained in a training stage before a training stage in which the latest separation graph is obtained,
cause the display unit to display the display screen, and
receive selection of a past machine learning model corresponding to the past separation graph from a user as a machine learning model to be used in operation, and
when selection of the past machine learning model is received, the processor
identifies all training images for training the selected past machine learning model, and
trains a machine learning model in an initial state before starting training with all the identified training images, thereby reproducing the selected past machine learning model.

12. The image processing device according to claim 1, wherein
the processor is configured to restart the re-training of the machine learning model in response to a user instruction even after completing the training of the machine learning model,
the processor inputs a new validation image different from an existing validation image to the machine learning model and executes a process of classifying the new validation image into the plurality of classes,
the processor evaluates accuracy of the classification based on a degree of separation between the plurality of classes obtained by the classification for the new validation image, and
if it is evaluated that the re-training of the machine learning model is necessary based on an evaluation result of the accuracy of the classification, the processor extracts an validation image whose classification result has a high possibility to be erroneous from among the new validation image to automatically re-train the machine learning model, and
on the other hand, if it is evaluated that the re-training of the machine learning model is unnecessary, the processor ends the training of the machine learning model.

13. The image processing device according to claim 1, wherein
the processor is configured to select:
a process of holding in advance labels related to the classification of existing training images and validation images used for the training of the machine learning model in operation and adding a training image by adding a new image acquired after starting the operation to the existing training images; and
a process of initializing the labels related to the classification of the existing training images and validation images used for the training of the machine learning model in operation and training the machine learning model with all images including a new image acquired after starting the operation.

14. The image processing device according to claim 1, wherein
if it is evaluated that the re-training of the machine learning model is unnecessary, after completing the training of the machine learning model, the processor
inputs a plurality of evaluation images different from the plurality of training images and the plurality of validation images to the machine learning model,
executes classification of classifying the plurality of evaluation images into the plurality of classes, and
evaluates accuracy of the classification.

15. An image processing method for inputting an image to a machine learning model and executing classification of classifying the image into a plurality of classes, the image processing method comprising:
(1) a step of training the machine learning model with a plurality of training images;
(2) a step of inputting a plurality of validation images to the machine learning model trained with the plurality of training images and executing classification of classifying the plurality of validation images into the plurality of classes;
(3) a step of obtaining a degree of separation between the plurality of classes by the classification of the plurality of validation images and evaluating accuracy of the classification of the plurality of validation images based on the obtained degree of separation between the plurality of classes; and
(4) a step of evaluating whether re-training of the machine learning model is necessary based on an evaluation result of the accuracy of classification of the plurality of validation images,
extracting an validation image whose classification result has a relatively high possibility to be erroneous from among the plurality of validation images to automatically re-train the machine learning model if it is evaluated that the re-training of the machine learning model is necessary, and
completing the training of the machine learning model if it is evaluated that the re-training of the machine learning model is unnecessary.
